(19) United States
(12) Patent Application Publication
(10) Pub. No.: US 2026/0299488 A1
(43) Pub. Date: Oct. 1, 2026

(54) SHEET FEEDING APPARATUS AND IMAGE FORMING SYSTEM

(71) Applicant: CANON KABUSHIKI KAISHA, Tokyo (JP)

(72) Inventors: SHO OTA, Chiba (JP); HIROSHI SAITO, Ibaraki (JP); ISAO KANNARI, Saitama (JP); KOHEI SUZUKI, Chiba (JP)

(21) Appl. No.: 19/572,219

(22) Filed: Mar. 19, 2026

(30) Foreign Application Priority Data
Mar. 26, 2025 (JP) 2025-051528

(51) Int. Cl. G03G 15/00

(52) U.S. Cl. CPC G03G 15/6511; G03G 2215/004; G03G 2215/00409

(57) ABSTRACT

A sheet feeding apparatus includes a first suction portion for attracting, by suction, an uppermost sheet of the sheets, a first blowing portion for blowing air onto the sheets from a downstream side toward an upstream side, and a controller capable of executing a first mode in which a first sheet is fed and a second mode in which a second sheet is fed, the first sheet having a first grammage, and the second sheet having a second grammage larger than the first grammage. The controller is configured to in the first mode, start the suction of the uppermost sheet by the first suction portion after starting blowing of the air by the first blowing portion, and in the second mode, start the suction of the uppermost sheet by the first suction portion before starting the blowing of the air by the first blowing portion.

### BACKGROUND

### Field of the Technology

The present disclosure relates to a sheet feeding apparatus that feeds a sheet, and an image forming system.

### Description of the Related Art

There is an image forming system including a separation air unit that blows air onto a sheet toward the upstream side in a sheet feeding direction, and a first suction unit and a second suction unit that attract an uppermost sheet by suction respectively at two positions in the sheet feeding direction (see Japanese Patent Application Laid-Open No. 2024-169261).

In recent years, there has been a demand for an image forming system to support printing on sheets of various types. Therefore, it is desired that separation failure is suppressed even for a sheet of a type whose uppermost sheet is difficult to separate from a sheet stack, such as a cardboard or a coated paper sheet.

### SUMMARY

Therefore, the present disclosure provides a sheet feeding apparatus and an image forming system capable of suppressing a separation failure of sheets.

According to a first aspect of the present disclosure, a sheet feeding apparatus includes a sheet supporting portion configured to support sheets, a first suction portion configured to attract, by suction, an uppermost sheet of the sheets supported on the sheet supporting portion, a first blowing portion configured to blow air onto the sheets supported on the sheet supporting portion from a downstream side toward an upstream side in a sheet feeding direction, and a controller capable of executing a first mode in which a first sheet supported on the sheet supporting portion is fed and a second mode in which a second sheet supported on the sheet supporting portion is fed, the first sheet having a first grammage, and the second sheet having a second grammage larger than the first grammage. The controller is configured to in the first mode, start the suction of the uppermost sheet by the first suction portion after starting blowing of the air by the first blowing portion, and in the second mode, start the suction of the uppermost sheet by the first suction portion before starting the blowing of the air by the first blowing portion.

According to a second aspect of the present disclosure, a sheet feeding apparatus includes a sheet supporting portion configured to support sheets, a first suction portion configured to attract, by suction, an uppermost sheet of the sheets supported on the sheet supporting portion, a first blowing portion configured to blow air onto the sheets supported on the sheet supporting portion from a downstream side toward an upstream side in a sheet feeding direction, and a controller capable of executing a first mode in which a sheet of a first type supported on the supporting portion is fed and a second mode in which a sheet of a second type supported on the sheet supporting portion is fed, the second type having a higher rigidity than the first type. The controller is configured to in the first mode, start the suction of the uppermost sheet by the first suction portion after starting blowing of the air by the first blowing portion, and in the second mode, start the suction of the uppermost sheet by the first suction portion before starting the blowing of the air by the first blowing portion.

According to a third aspect of the present disclosure, a sheet feeding apparatus includes a sheet supporting portion configured to support sheets, a first suction portion configured to attract, by suction, an uppermost sheet of the sheets supported on the sheet supporting portion, a second suction portion disposed at a position upstream of the first suction portion in a sheet feeding direction and configured to attract, by suction, the uppermost sheet of the sheets supported on the sheet supporting portion, a first blowing portion configured to blow air onto the sheets supported on the sheet supporting portion from a downstream side toward an upstream side in the sheet feeding direction, and a controller capable of executing a third mode in which a sheet of a third type supported on the supporting portion is fed and a fourth mode in which a sheet of a fourth type supported on the sheet supporting portion is fed, sheets of the fourth type sticking more strongly to each other than sheets of the third type. The controller is configured to in the third mode, start the suction of the uppermost sheet by the second suction portion after starting blowing of the air by the first blowing portion, and in the fourth mode, start the suction of the uppermost sheet by the second suction portion before starting the blowing of the air by the first blowing portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic section view illustrating an image forming system according to a first embodiment.

FIG. 2 is an enlarged section view of an image forming apparatus according to the first embodiment.

FIG. 3 is a perspective view of a storage container according to the first embodiment.

FIG. 4 is a front view of a feeding unit according to the first embodiment.

FIG. 5 is a top view of the feeding unit according to the first embodiment.

FIG. 6 is a side view of a separation air unit according to the first embodiment as viewed from the downstream side in a feeding direction.

FIG. 7 is a perspective view of a first suction unit and a second suction unit according to the first embodiment as viewed from diagonally below.

FIG. 8 is a bottom view of the first suction unit in a state in which a separation belt is detached as viewed from below.

FIG. 9 is a bottom perspective view of the second suction unit in a state in which a chamber is detached as viewed from diagonally below.

FIG. 10 is a block diagram illustrating a control system of a feeding deck according to the first embodiment.

FIG. 11A is a front view of the feeding unit in a state in which only separation air is blown.

FIG. 11B is a front view of the feeding unit in a state in which only first suction air is sucked.

FIG. 11C is a front view of the feeding unit in a state in which the separation air is blown and the first suction air is sucked.

FIG. 12A is a front view illustrating a state of a sheet in a case where a sheet having a grammage of 400 gsm or less is attracted by suction of the first suction air and separation air is blown thereonto.

FIG. 12B is a front view illustrating a state of a sheet in a case where a sheet having a grammage larger than 400 gsm is attracted by suction of the first suction air and separation air is blown thereonto.

FIG. 13 is a flowchart illustrating feeding control of a first mode for feeding a sheet other than a cardboard according to the first embodiment.

FIG. 14 is a timing chart illustrating a timing at which each solenoid is turned on in the feeding control of the first mode for feeding a sheet other than a cardboard according to the first embodiment.

FIG. 15 is a flowchart illustrating feeding control of a second mode for feeding a cardboard according to the first embodiment.

FIG. 16 is a timing chart illustrating a timing at which each solenoid is turned on in the feeding control of the second mode for feeding a cardboard according to the first embodiment.

FIG. 17 is a schematic section view of an image forming system according to a second embodiment.

FIG. 18 is a perspective view of a storage container according to the second embodiment.

FIG. 19 is a perspective view of a feeding unit according to the second embodiment as viewed from diagonally below.

FIG. 20 is a front view of the feeding unit according to the second embodiment.

FIG. 21 is a block diagram illustrating a control system of a feeding deck according to the second embodiment.

FIG. 22 is a flowchart illustrating feeding control of a third mode for feeding a sheet other than a coated paper sheet according to the second embodiment.

FIG. 23 is a timing chart illustrating a timing at which each solenoid is turned on in the feeding control of the third mode for feeding a sheet other than a coated paper sheet according to the second embodiment.

FIG. 24 is a flowchart illustrating feeding control of a fourth mode for feeding a coated paper sheet according to the second embodiment.

FIG. 25 is a timing chart illustrating a timing at which each solenoid is turned on in the feeding control of the fourth mode for feeding a coated paper sheet according to the second embodiment.

### DESCRIPTION OF THE EMBODIMENTS

### First Embodiment

A first embodiment will be described below with reference to drawings. To be noted, although the embodiments described below are preferable embodiments of the present disclosure and therefore various technically preferable limitations are given thereto, the present disclosure is not limited to what is described below, and not all elements described in the present embodiment are necessary requirements for the present disclosure.

### Schematic Configuration of Image Forming System

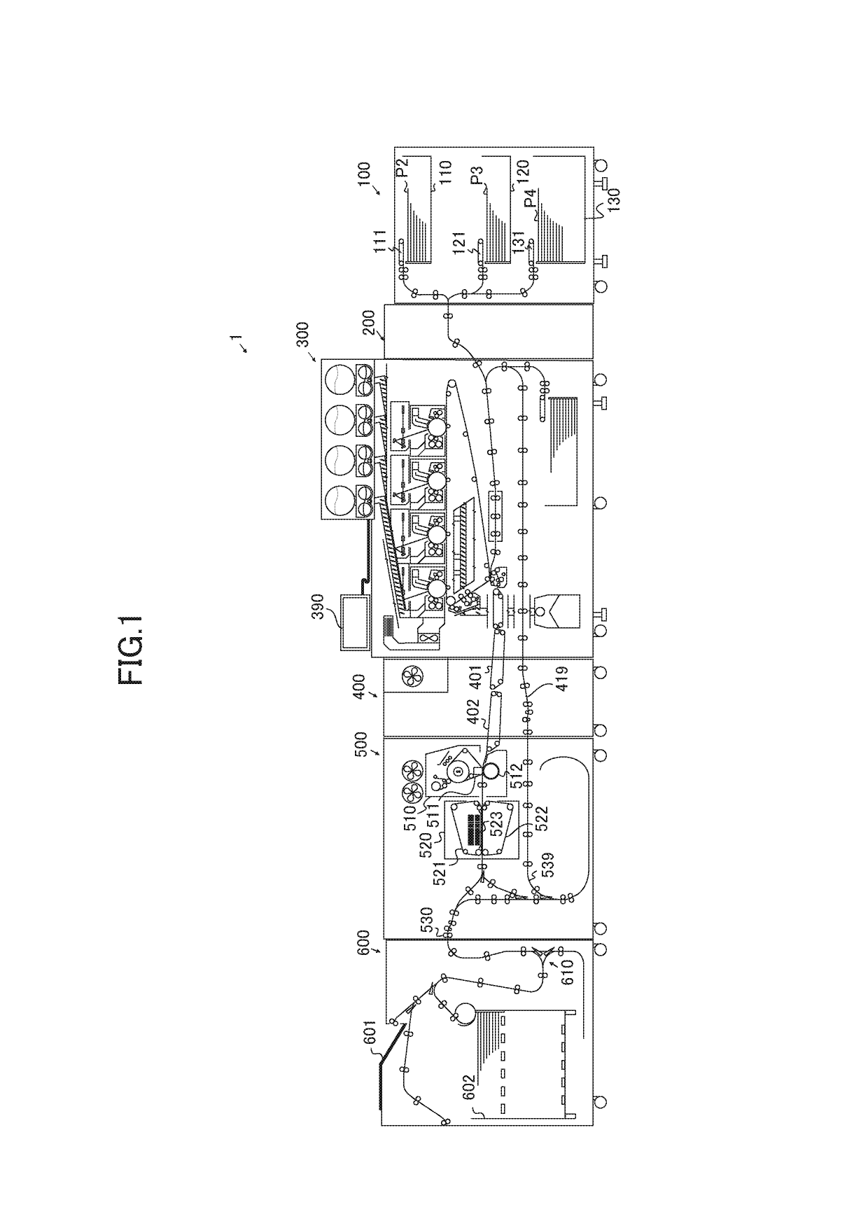

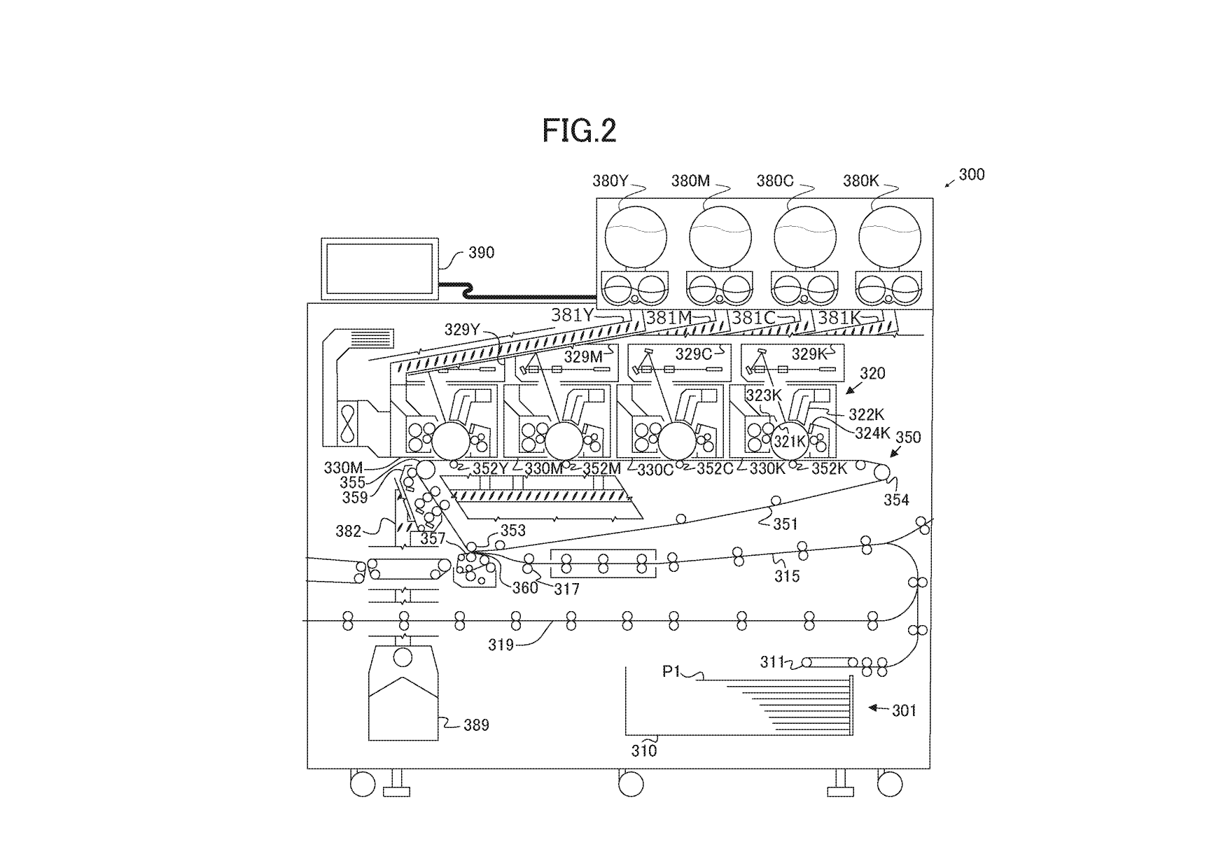

First, an image forming system 1 according to the first embodiment will be described with reference to FIG. 1. FIG. 1 is a schematic section view of the image forming system according to the first embodiment. FIG. 2 is an enlarged section view of an image forming apparatus according to the first embodiment.

As illustrated in FIG. 1, the image forming system 1 includes a feeding deck 100, a first relay path unit 200, an image forming apparatus 300, a second relay path unit 400, a fixing apparatus 500, and a stacker 600 that are coupled and arranged in this order from the right side in FIG. 1. To be noted, the “front” in the present specification is a position where a user faces the image forming system 1 for operation as illustrated in FIG. 1 unless described otherwise. That is, the side on which an operation portion 390 that the user operates and that will be described in detail later is the front side.

### Feeding Deck

The feeding deck 100 serving as a sheet feeding apparatus includes a plurality of storage containers 110, 120, and 130 that store and support sheets serving as recording materials. The storage containers 110, 120, and 130 are arranged in this order from the upper side in the vertical direction in a casing of the feeding deck 100. A sheet P2 stored in the storage container 110 is picked up and fed into a sheet conveyance path of the feeding deck 100 by a feeding unit 111. Similarly, a sheet P3 stored in the storage container 120 is picked up and fed into a sheet conveyance path of the feeding deck 100 by a feeding unit 121. Similarly, a sheet P4 stored in the storage container 130 is picked up and fed into a sheet conveyance path of the feeding deck 100 by a feeding unit 131. The sheet fed into the sheet conveyance path of the feeding deck 100 is conveyed toward the first relay path unit 200 downstream thereof by a conveyance roller.

### First Relay Path Unit

The first relay path unit 200 includes a main conveyance path for conveying a sheet conveyed from the feeding deck 100, and conveys the sheet to a unit downstream thereof (the image forming apparatus 300 in the present embodiment).

### Image Forming Apparatus

As illustrated in FIG. 2, the image forming apparatus 300 mainly includes a sheet feeding portion 301, an image forming portion 320, and a transfer unit 350. Among these, the image forming portion 320 includes image forming engines 330 each including a photosensitive drum (photosensitive member) 321, a charging device 322, a developing device 323, a drum cleaning device 324, and an exposing device 329. The transfer unit 350 includes an intermediate transfer belt 351, and a belt cleaning device 359 that collects toner on the intermediate transfer belt 351. To be noted, although the image forming portion 320 and the transfer unit 350 are defined as different units in the present embodiment, the definition of the image forming portion is not limited to this. For example, the image forming portion may be defined as an element including the transfer unit 350.

Next, the image forming portion 320 will be described in detail. The image forming portion 320 roughly includes image forming engines 330Y, 330M, 330C, and 330K. Here, the image forming engines 330Y to 330K are configured in almost the same manner except that the colors of toners used in developing devices 323Y, 323M, 323C, and 323K, which are respectively yellow, magenta, cyan, and black, are different. Here, the black image forming engine 330K will be described as a representative example, and description of the other image forming engines will be omitted.

The image forming engine 330K includes a photosensitive drum 321K, a charging device 322K, an exposing device 329K, a developing device 323K, and a drum cleaning device 324. The surface of the photosensitive drum 321K serving as a photosensitive member is uniformly charged by the charging device 322K. Then, an electrostatic latent image is formed by the exposing device 329K driven on the basis of a signal of image information. The exposing device 329K in the present embodiment is a laser scanner that scans the photosensitive drum 321K with laser light. The electrostatic latent image formed on the photosensitive drum 321K by the exposure is developed into a toner image of black toner by the developing device 323K, and the toner image developed on the photosensitive drum 321K is transferred onto the intermediate transfer belt 351 by a primary transfer roller 352K. Residual toner remaining on the photosensitive drum 321K without being transferred is collected by the drum cleaning device 324, and thus the surface of the photosensitive drum 321K is cleaned.

To be noted, the exposing device 329K may be an exposing head that is formed in an elongated shape extending in a rotation axis direction (main scanning direction) of the photosensitive drum 321K and that exposes the photosensitive drum 321K by using a plurality of light emitting elements arranged in the rotation axis direction of the photosensitive drum 321K. Examples of the light emitting element that can be used for an exposing head include light emitting diodes and organic electroluminescence.

Next, the transfer unit 350 will be described in detail. The transfer unit 350 includes an intermediate transfer belt 351, primary transfer rollers 352, a driving roller 355 and stretching rollers 354 that stretch the intermediate transfer belt 351, and a secondary transfer inner roller 353 and a secondary transfer roller 357 that constitute a secondary transfer portion 360. To be noted, the secondary transfer inner roller 353 may be configured to also function as the driving roller. The intermediate transfer belt 351 is stretched by the secondary transfer inner roller 353, the driving roller 355, and the plurality of stretching rollers 354, and is driven to move in a counterclockwise direction in the drawing. In addition, the transfer unit 350 includes a belt cleaning device 359. The belt cleaning device 359 collects residual toner remaining on the intermediate transfer belt 351 without being transferred from the intermediate transfer belt 351 onto the sheet, that is, cleans the intermediate transfer belt 351. To be noted, the toner collected by the belt cleaning device 359 and the drum cleaning device 324 described above is collected into a cleaner box 389 through a toner conveyance path 382.

In addition, the image forming apparatus 300 includes developer replenishment containers 380Y, 380M, 380C, and 380K. The developer replenishment containers 380Y, 380M, 380C, and 380K respectively store yellow, magenta, cyan, and black toners. The developer replenishment container 380Y is connected to the developing device 322Y via a developer conveyance path 381Y. When toner in the developing device 322Y is consumed by image formation, the developing device 322Y is replenished with toner from the developer replenishment container 380Y via the developer conveyance path 381Y. The relationship between the developer replenishment container 380Y and the developing device 322Y has been described, and the developer replenishment container and the developing device are connected to each other in substantially the same configuration for the other colors, and therefore the description thereof will be omitted. To be noted, the image forming apparatus 300 includes an element to detect the toner remainder amount in the developer replenishment container, and a user can replace the developer replenishment container in the case where the toner in the developer replenishment container has run out.

Meanwhile, the sheet feeding portion 301 includes a storage container 310 serving as a feeding cassette, and a feeding unit 311. The storage container 310 is disposed below the image forming portion 320 in the vertical direction. A sheet P1 fed by the feeding unit 311 from the storage container 310 is conveyed to a registration roller pair 317 via a conveyance path 315, have the skew thereof corrected by the registration roller pair 317, and is conveyed to the secondary transfer portion 360.

In addition, the image forming apparatus 300 includes a reverse conveyance path 319. The reverse conveyance path 319 is a path for conveying the sheet conveyed from a second relay path unit 400 that is provided on the downstream side in the conveyance direction and that will be described in detail later to the secondary transfer portion 360 again. To be noted, although a configuration in which the reverse conveyance path 319 of the image forming apparatus 300 receives a sheet from the second relay path unit 400 has been described as an example in the present embodiment, the configuration is not limited to this. For example, a configuration in which the reverse conveyance path 319 of the image forming apparatus 300 directly receives a sheet from the fixing apparatus 500 may be employed.

Next, the operation of the image forming apparatus 300, that is, the image formation process executed by the image forming apparatus 300 will be described. In the image forming engines 330Y to 330K, the electrostatic latent image formed on each photosensitive drum 321 is developed as a toner image of a corresponding color by the corresponding one of the developing devices 323. The toner image developed on each photosensitive drum 321 is subjected to a predetermined pressurizing force and a primary transfer voltage by the corresponding one of the primary transfer rollers 352 disposed to oppose the photosensitive drum 321 with the intermediate transfer belt 351 therebetween. As a result of this, the toner image on the photosensitive drum 321 is transferred onto the intermediate transfer belt 351 through primary transfer. At this time, in the image formation process of each color performed by the image forming engines 330Y to 330K, the toner image of each color is transferred onto the intermediate transfer belt 351 through primary transfer at such a timing that the toner image is sequentially superimposed on a toner image of an upstream color in the movement direction of the intermediate transfer belt 351. As a result, a full-color toner image is formed on the intermediate transfer belt 351, and is conveyed to the secondary transfer portion 360. To be noted, transfer residual toner of a small amount remaining on the photosensitive drum 321 is removed by the drum cleaning device 324, and preparation for the next image formation process is performed.

Meanwhile, a sheet fed from the storage container 110, 120, or 130 of the feeding deck 100 or the storage container 310 of the image forming apparatus 300 is conveyed to a registration roller pair 317 disposed in the middle of the conveyance path 315. Then, the skew and the conveyance timing of the sheet are corrected by the registration roller pair 317, and then the sheet is conveyed to the secondary transfer portion 360. The secondary transfer portion 360 is a transfer nip portion formed by the secondary transfer inner roller 353 and the secondary transfer roller 357 opposing each other. At the secondary transfer portion 360, a secondary transfer voltage is applied to the secondary transfer inner roller 353, and thus the toner image is transferred from the intermediate transfer belt 351 through secondary transfer. To be noted, the transfer residual toner remaining on the intermediate transfer belt 351 after passing through the secondary transfer portion 360 is removed from the intermediate transfer belt 351 by the belt cleaning device 359. Then, the sheet onto which the toner image has been transferred through secondary transfer at the secondary transfer portion 360 is conveyed to the fixing apparatus 500 that will be described later.

### Second Relay Path Unit

As illustrated in FIG. 1, the second relay path unit 400 includes a first conveyance belt 401 and a second conveyance belt 402, and conveys the sheet from the image forming apparatus 300 to the fixing apparatus 500 that will be described later. That is, the second relay path unit 400 is provided to fill in the gap between the height of a discharge port through which the sheet is discharged from the image forming apparatus 300 and the height of an inlet port for the fixing apparatus 500 to receive the sheet. The second relay path unit 400 supports the first conveyance belt 401 disposed to extend also through the image forming apparatus 300, and supports the second conveyance belt 402 disposed to extend also through the fixing apparatus 500. Further, the sheet bearing an unfixed toner image is conveyed by the first conveyance belt 401 and the second conveyance belt 402 to the fixing apparatus 500 that is positioned downstream in the conveyance direction

In addition, the second relay path unit 400 includes a reverse conveyance path 419 that conveys the sheet by a plurality of conveyance roller pairs from the fixing apparatus 500 to the image forming apparatus 300 when performing duplex printing. The reverse conveyance path 419 is disposed below the first conveyance belt 401 and the second conveyance belt 402 in the vertical direction.

### Fixing Apparatus

The fixing apparatus 500 includes a fixing unit 510, a cooling unit 520, a discharge roller pair 530, a reverse conveyance path 539, and the like. The sheet conveyed from the second relay path unit 400 described above is conveyed to the fixing unit 510. The fixing unit 510 includes a fixing belt 511 and a fixing roller 512 that form a fixing nip portion, and the toner image borne on the sheet is pressurized and heated in the fixing nip portion, and is thus melted on the surface of the sheet.

The sheet having passed through the fixing unit 510 is conveyed to the cooling unit 520. The cooling unit 520 includes an upper belt 521, a lower belt 522, a heat sink 523, and a cooling fan. The upper belt 521 is rotationally driven in a clockwise direction in the drawing, and the lower belt 522 is rotationally driven in a counterclockwise direction in the drawing. The sheet having passed through the fixing nip portion of the fixing unit 510 is conveyed to a gap between the upper belt 521 and the lower belt 522, and is nipped and conveyed between the belts. The belts absorb heat from the sheet and the molten toner. The heat sink 523 is in contact with the inner peripheral surface of the stretched upper belt 521, absorbs heat from the upper belt 521, and dissipates the heat. The heat sink 523 is cooled by the cooling fan. To be noted, the heat sink 523 may be disposed inside the lower belt 522. In addition, a cooling mechanism using a refrigerant may be provided instead of the heat sink 523 and the cooling fan.

The cooling unit 520 absorbs heat from the toner image on the sheet, and thus accelerates the fixation of the toner image to the sheet. By providing the cooling unit 520, so-called discharge adhesion in which sheets stacked on a discharge tray 601 or a stack tray 602 that will be described later stick together via unfixed toner can be suppressed.

The sheet to which the toner image is fixed is conveyed by the discharge roller pair 530 to the stacker 600 positioned downstream in the conveyance direction in the case of simplex printing. In contrast, in the case of duplex printing, the sheet is conveyed to the reverse conveyance path 539, the front side and the back side thereof are flipped, and the sheet is conveyed to the image forming apparatus 300 again. The image formation process on the back surface (second surface) of the sheet is substantially the same as the case described above, and therefore description thereof will be omitted.

### Stacker

The stacker 600 is an apparatus capable of supporting a large amount of sheets thereon. The stacker 600 includes a discharge tray 601 that is positioned outside the apparatus and that supports the sheets, and a stack tray 602 constituted by a lift table and an eject table. In addition, the stacker 600 also has a finishing function of stacking sheets while sorting the sheets. The sheet having passed through an inspection unit is stacked on the lift table of the stack tray 602 and by conveyance rollers of the stacker 600. The stacker 600 includes a reversing portion 610 capable of causing the orientation of the conveyed sheet to match the orientation of the sheets stacked on the stack tray 602, and is also capable of stacking the sheet on the stack tray 602 after switching back the sheet.

### Details of Configuration of Feeding Deck

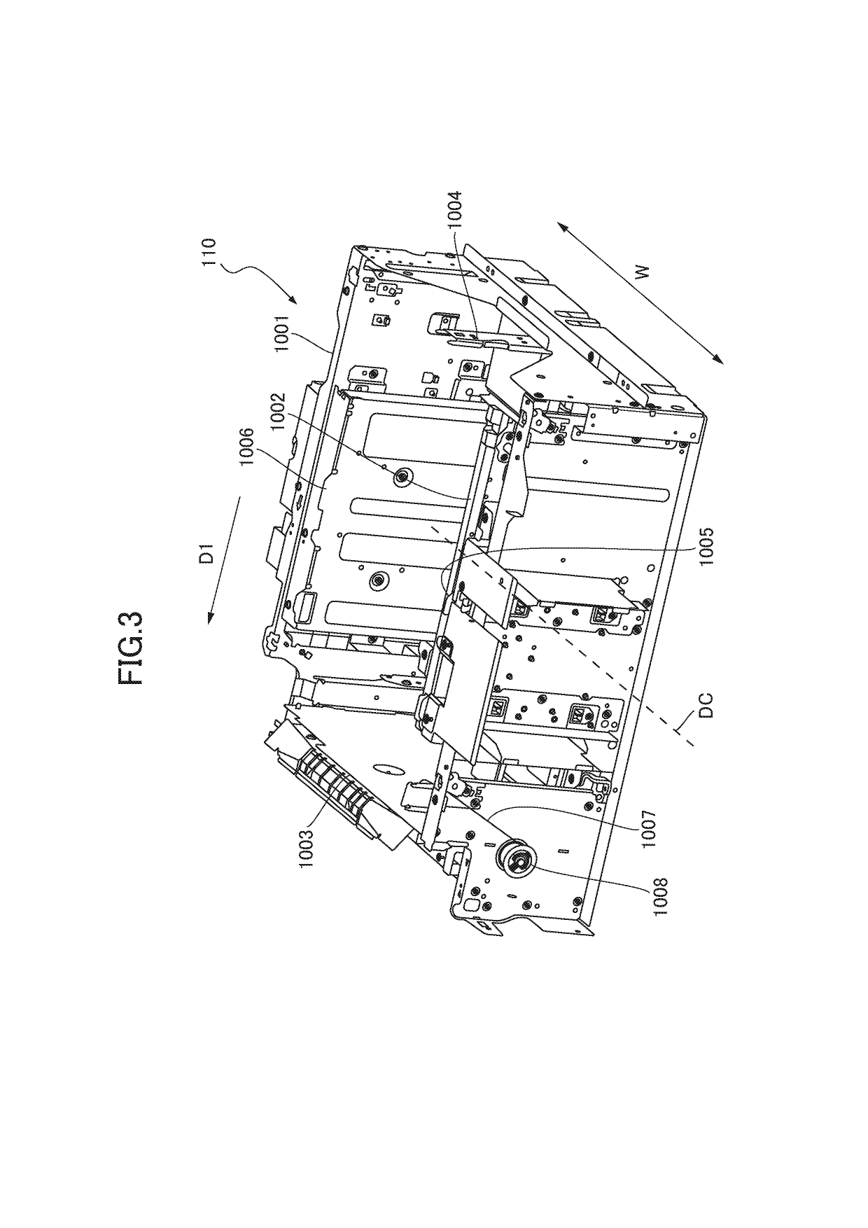

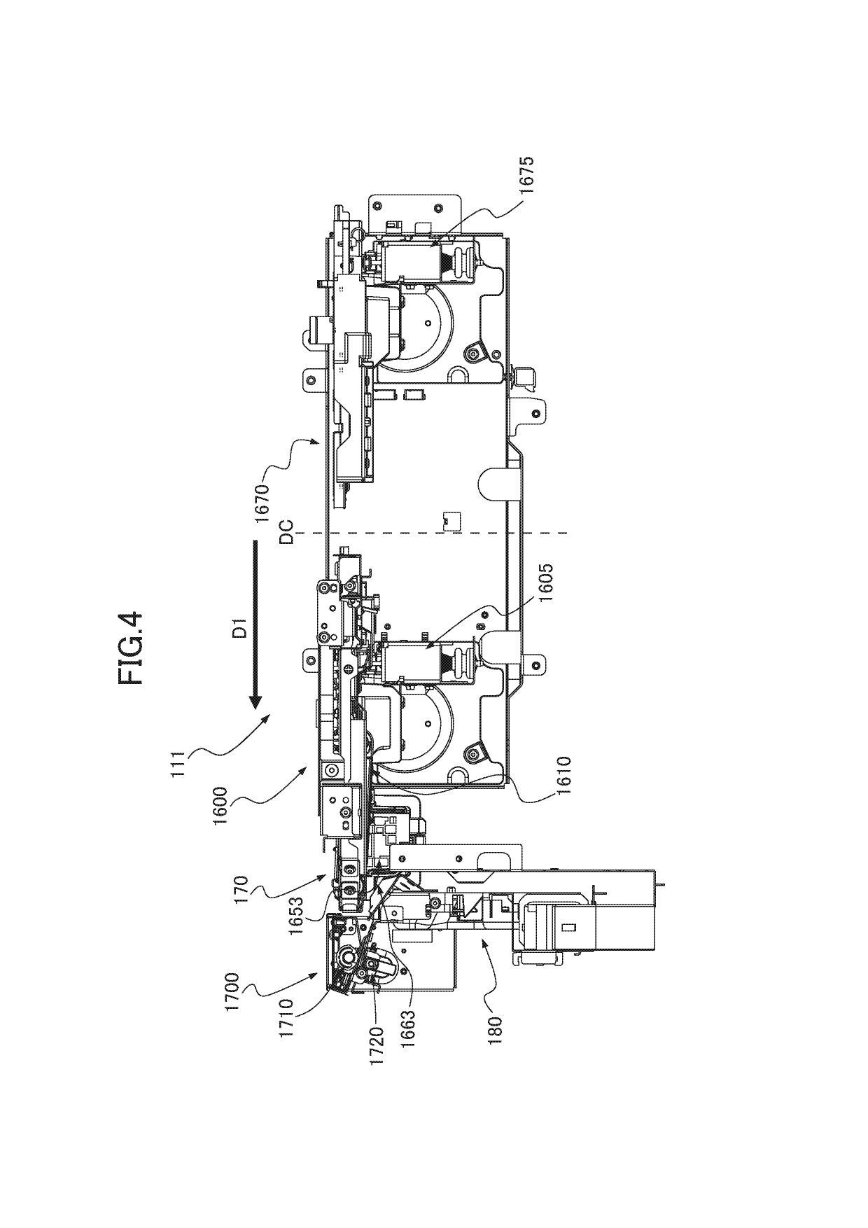

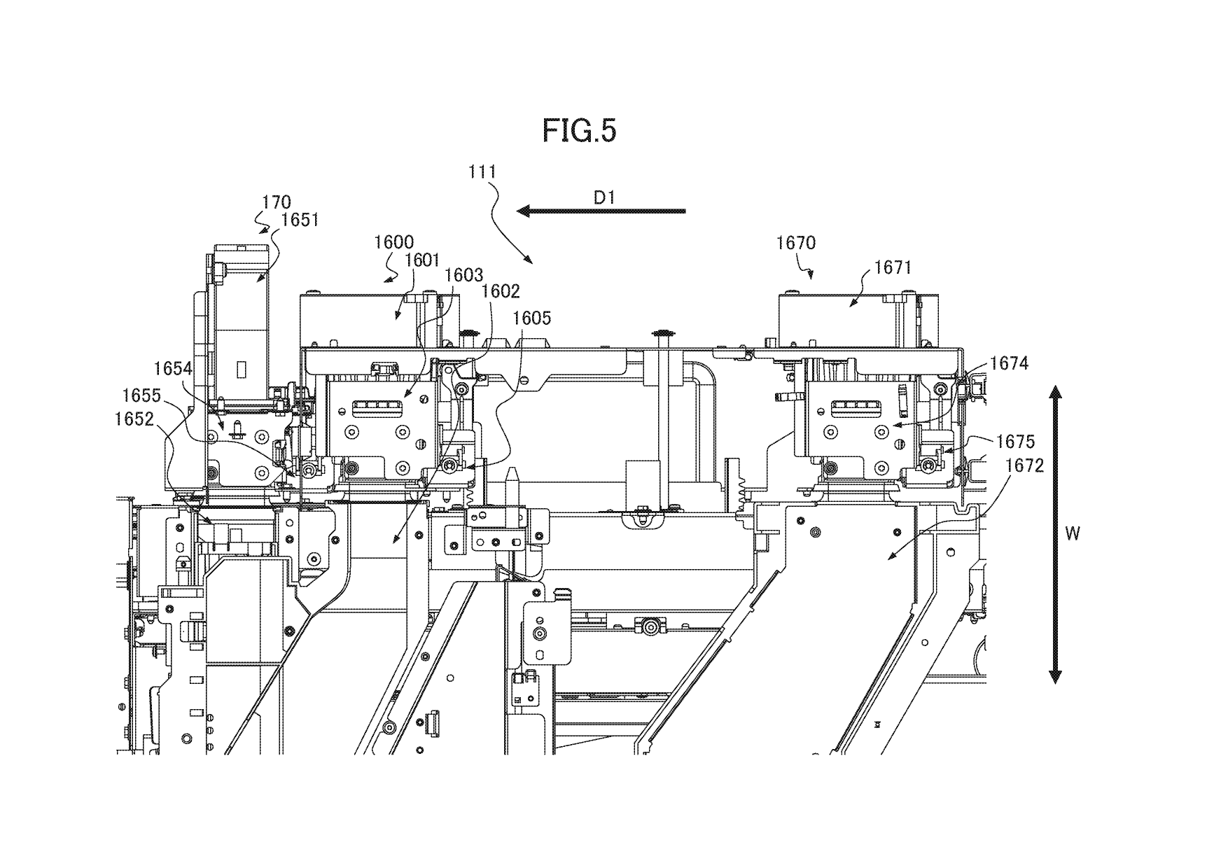

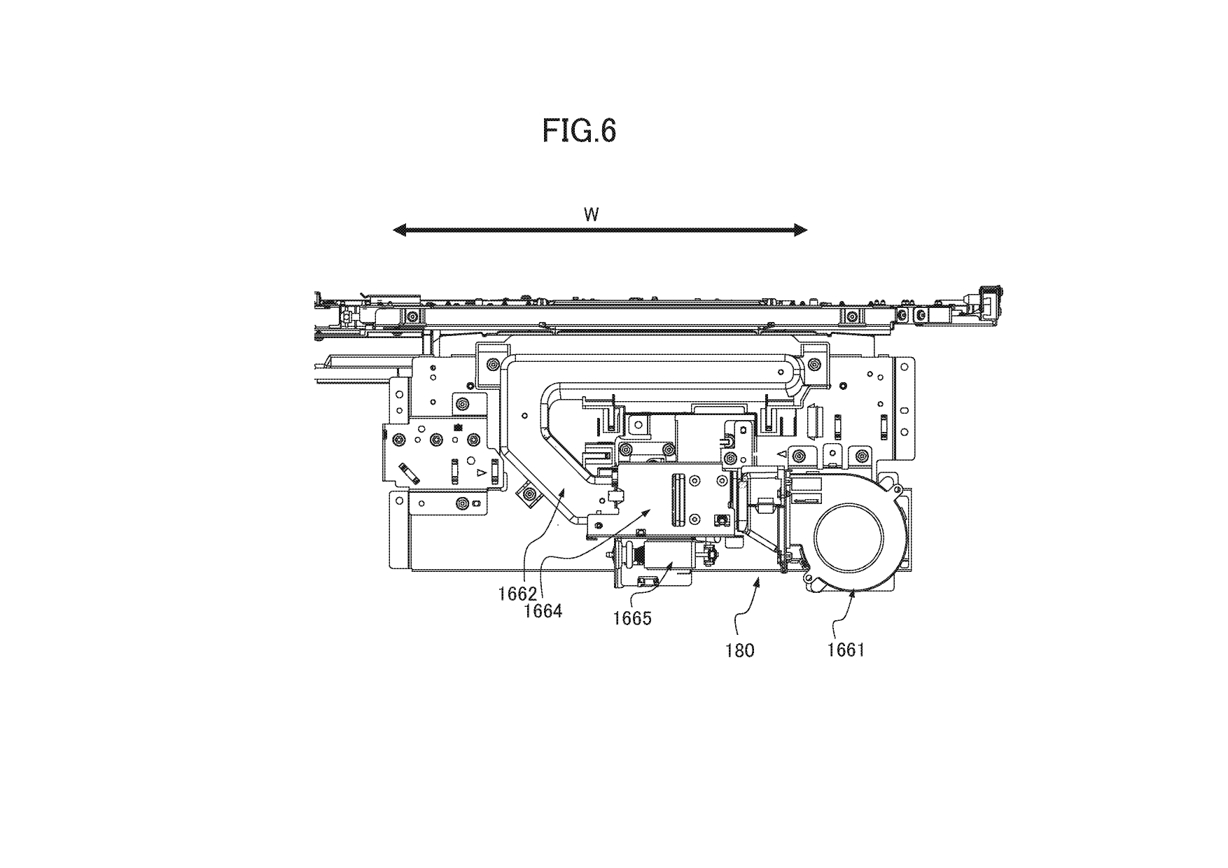

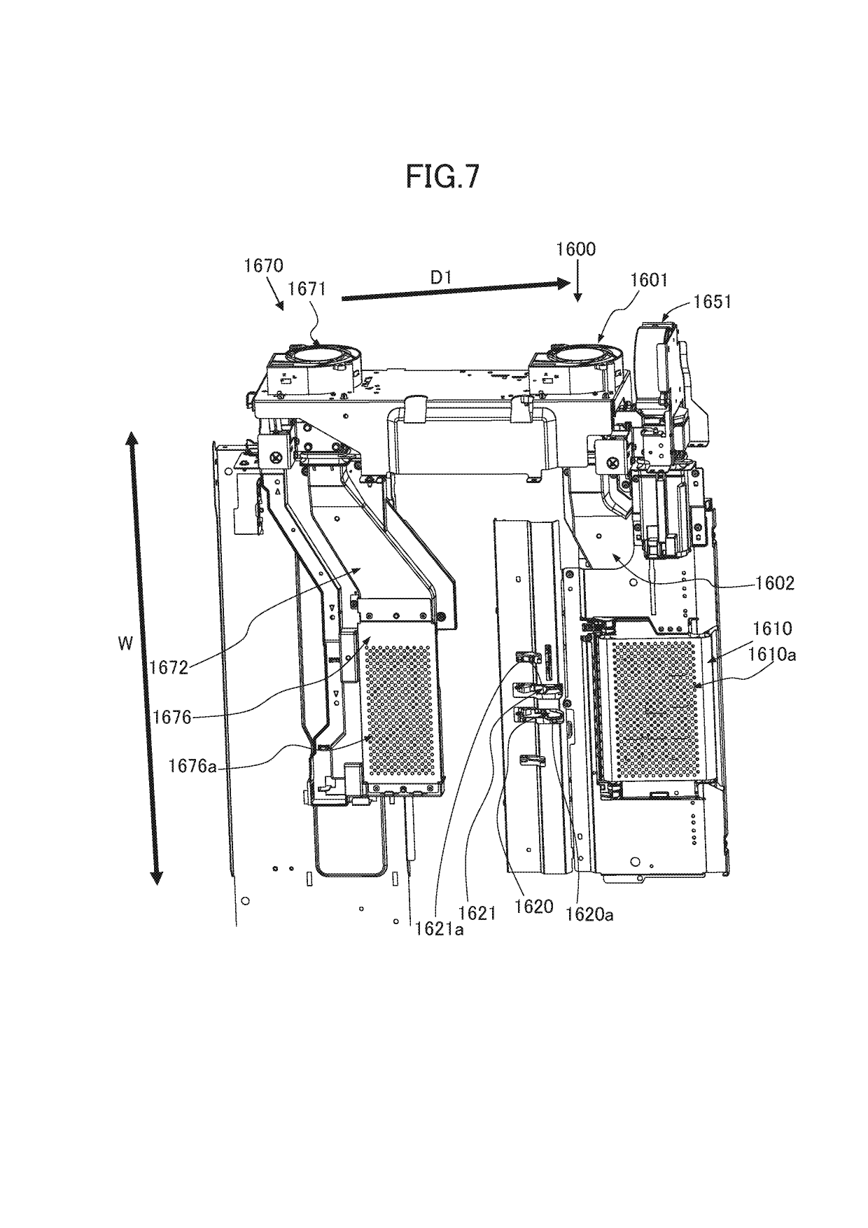

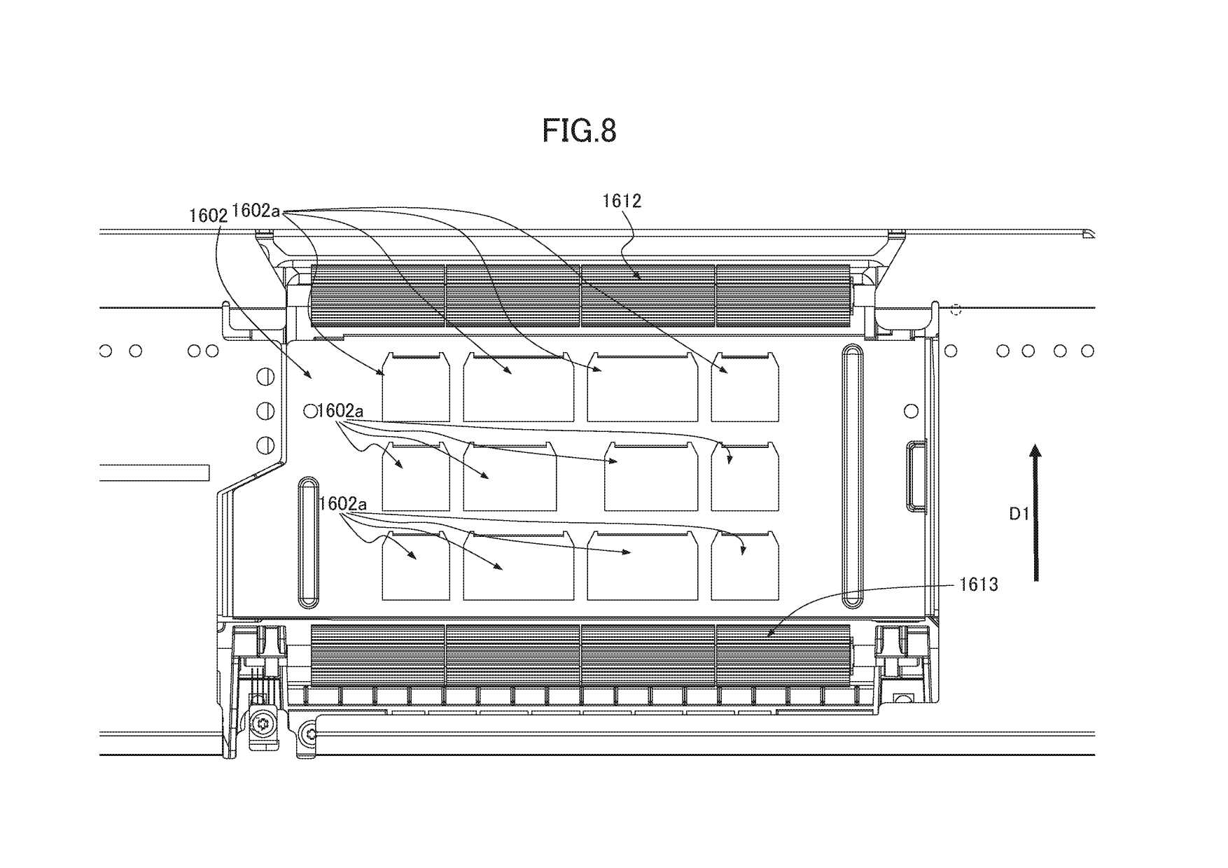

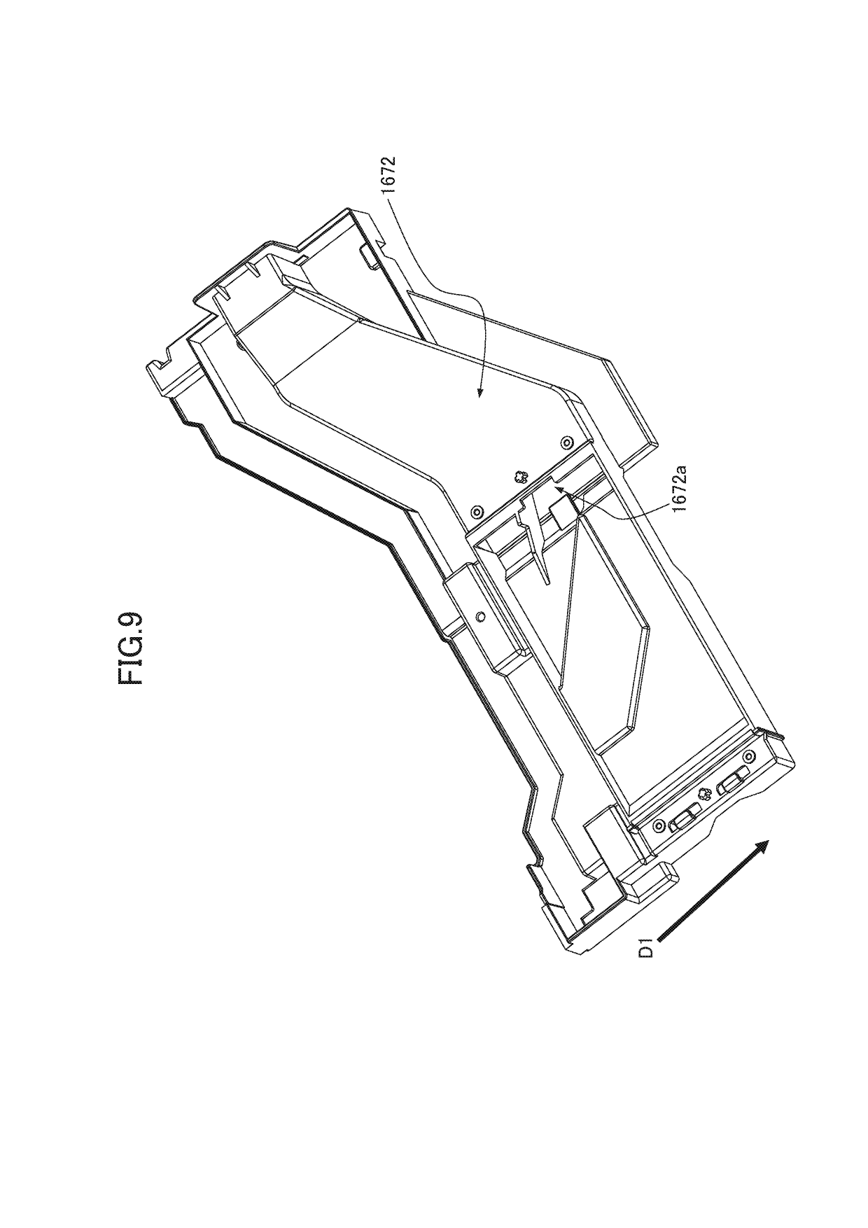

Next, the details of the configuration of the feeding deck 100 will be described with reference to FIGS. 3-9. FIG. 3 is a perspective view of a storage container according to the first embodiment. FIG. 4 is a front view of the feeding unit according to the first embodiment. FIG. 5 is a top view of the feeding unit according to the first embodiment. FIG. 6 is a side view of a separation air unit according to the first embodiment as viewed from the downstream side in the feeding direction. FIG. 7 is a perspective view of a first suction unit and a second suction unit according to the first embodiment as viewed from diagonally below. FIG. 8 is a bottom view of the first suction unit as viewed from below in a state in which a separation belt is detached. FIG. 9 is a bottom perspective view of the second suction unit as viewed from diagonally below in a state in which a chamber is detached.

As described above, the sheets stored in the three storage containers 110, 120, and 130 included in the feeding deck 100 are respectively fed by the feeding units 111, 121, and 131 corresponding to the respective storage containers. Since the storage containers 110, 120 and 130 have substantially the same configuration and the feeding units 111, 121, and 131 have substantially the same configuration, the storage container 110, the feeding unit 111, and the elements therearound will be described in detail below. To be noted, the storage containers 110, 120, and 130 do not need to have the same configuration, and the feeding units 111, 121, and 131 do not need to have the same configuration. For example, the maximum stacking number of sheets that can be stored in the storage container and the size of sheets that can be stored in the storage container may differ between the storage containers 110, 120, and 130.

### Storage Container

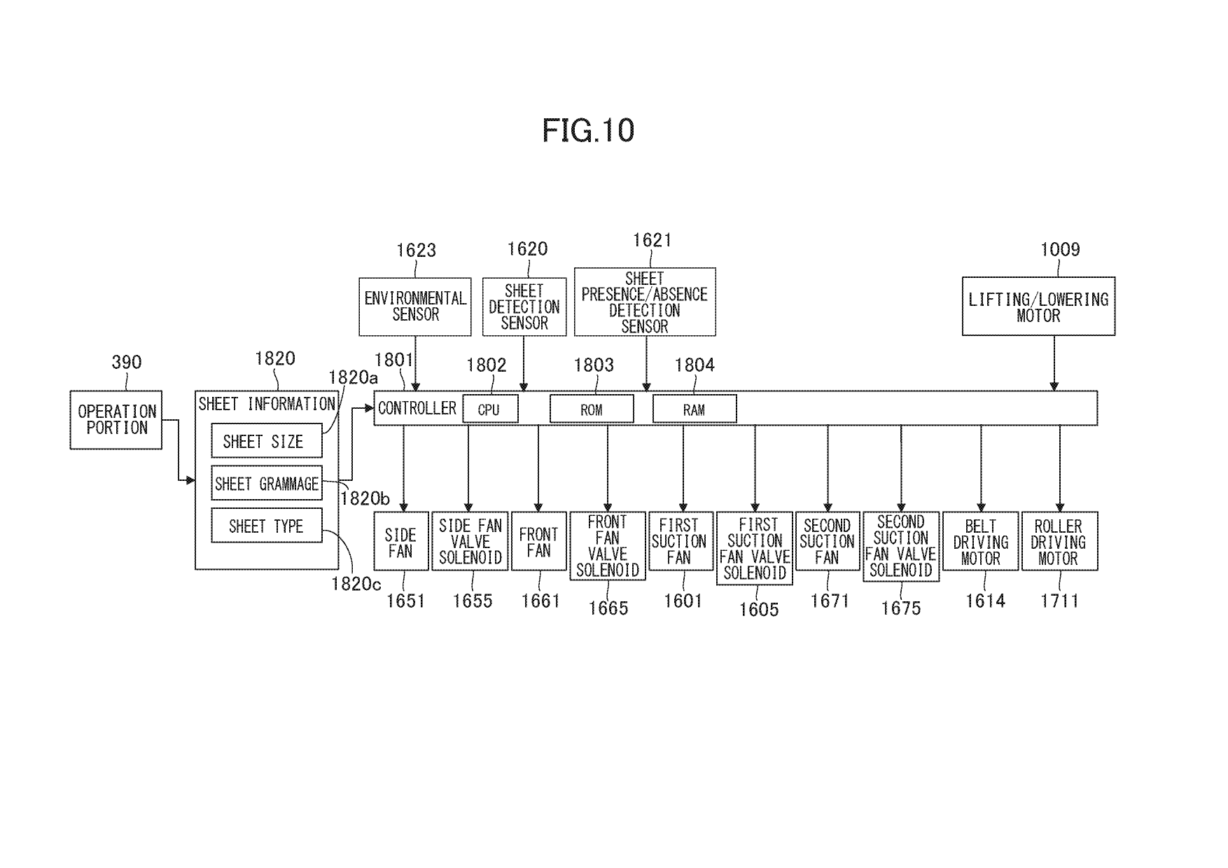

First, the configuration of the storage container 110 in the feeding deck 100 will be described. As illustrated in FIG. 3, the storage container 110 includes a body portion 1001, a lifter plate 1002 supported by the body portion 1001, a leading end guide 1003, a trailing end guide 1004, a first side guide 1005, and a second side guide 1006. The lifter plate 1002 serving as a sheet supporting portion supports a sheet, and is suspended by a lifter wire 1007. Further, the lifter plate 1002 is configured to be movable in the up-down direction while maintaining a state in which the sheet thereon is horizontal, as a result of the lifter wire 1007 being wound up and delivered out by a wire pulley 1008 driven by a lifting/lowering motor 1009 (see FIG. 10).

The leading end guide 1003 regulates the position of the leading end of the sheets stacked on the lifter plate 1002, that is, the position of the downstream end of the sheets in the sheet feeding direction (hereinafter, simply referred to as a “feeding direction”) D1. The trailing end guide 1004 regulates the position of the trailing end of the sheets stacked on the lifter plate 1002, that is, the position of the upstream end of the sheets in the feeding direction D1. The first side guide 1005 and the second side guide 1006 are configured to be movable in the width direction W orthogonal to the feeding direction D1, and regulate the position of the end portions in the width direction W of the sheets stacked on the lifter plate 1002. To be noted, the storage container 110 is configured to be attachable to and detachable from the body portion 1001 in the front-rear direction serving as the width direction W, is moved toward the first side guide 1005 side in the width direction W when being detached, and is moved toward the second side guide 1006 side when being attached.

### Feeding Unit

As illustrated in FIG. 4, the feeding unit 111 floats sheets by blowing air blown from an end surface of the sheet stack in the width direction, attracts sheets to a separation belt 1610 by suction air of a negative pressure, and separates one sheet from other sheets by separation air blown from the leading end side of the sheet stack. Further, the feeding unit 111 employs a full-air feeding system that feeds sheets one by one by rotating the separation belt 1610 without using a roller for separating sheets.

The feeding unit 111 includes a blowing air unit 170, a separation air unit 180, a first suction unit 1600, a separation belt 1610, a second suction unit 1670, and a driving roller unit 1700.

As illustrated in FIGS. 4 and 5, the blowing air unit 170 serving as a second blowing portion includes a side fan 1651 whose rotation speed can be controlled, a side duct 1652, a side nozzle 1653, and a side fan valve 1654. The side fan 1651 serving as a fourth fan is supported by the casing of the feeding deck 100 directly or via a frame or the like. The side fan 1651 is connected to the side duct 1652 having a tubular shape, and the side nozzle 1653 serving as a second nozzle is provided at the distal end of the side duct 1652. The side duct 1652 and the side nozzle 1653 are provided on the rear side and at a downstream end portion of the storage container 110 in the feeding direction D1.

The air (hereinafter referred to as blowing air) sent from the side fan 1651 passes through the side duct 1652 and is discharged from the side nozzle 1653. The side duct 1652 is configured to be movable in the width direction W in conjunction with the second side guide 1006 (see FIG. 3). As a result of this, the side nozzle 1653 from which the blowing air is discharged is disposed on the rear side near the leading end portion of the sheets stacked in the storage container 110.

The side fan valve 1654 serving as a fourth valve is provided between the side fan 1651 and the side duct 1652, and is configured to be openable and closable by a side fan valve solenoid 1655. By controlling the opening and closing of the side fan valve 1654, the blowing timing of the blowing air can be controlled.

As illustrated in FIGS. 4 and 6, the separation air unit 180 serving as a first blowing portion includes a front fan 1661, a front duct 1662, a front nozzle 1663, and a front fan valve 1664. The front fan 1661 is supported by the casing of the feeding deck 100 directly or via a frame or the like. The front fan 1661 is connected to the front duct 1662 having a tubular shape, and the front nozzle 1663 is provided at the distal end of the front duct 1662. The front duct 1662 and the front nozzle 1663 are provided at a downstream end portion of the storage container 110 in the feeding direction D1.

The air (hereinafter referred to as separation air) sent from the front fan 1661 serving as a third fan passes through the front duct 1662 and is discharged from the front nozzle 1663 serving as a first nozzle. The front nozzle 1663 from which the separation air is discharged is directed toward the separation belt 1610 positioned above the sheets stacked on the storage container 110

The front fan valve 1664 serving as a third valve is provided between the front fan 1661 and the front duct 1662, and is configured to be openable and closable by a front fan valve solenoid 1665. By controlling the opening and closing of the front fan valve 1664, the blowing timing of the separation air can be controlled.

As illustrated in FIGS. 4, 5, 7, and 8, the first suction unit 1600 serving as a first suction portion is disposed at a downstream portion that is a portion downstream of a center DC (see FIGS. 3 and 4) of the lifter plate 1002 (sheet S) in the feeding direction D1. The first suction unit 1600 includes a first suction fan 1601, a first suction chamber 1602, and a first suction fan valve 1603.

The first suction fan 1601 serving as a first fan is supported by the casing of the feeding deck 100 directly or via a frame or the like. The first suction chamber 1602 serving as a first chamber is connected to the first suction fan 1601, and has a space therein. In addition, the first suction chamber 1602 has openings 1602a at a position opposing the sheets stacked in the storage container 110, and the openings 1602a communicate with the inner space of the first suction chamber 1602. The first suction fan 1601 can generate a negative pressure in the inner space of the first suction chamber 1602.

The first suction fan valve 1603 serving as a first valve is provided between the first suction fan 1601 and the first suction chamber 1602, and is configured to be openable and closable by a first suction fan valve solenoid 1605. The inner pressure of the first suction chamber 1602 becomes a negative pressure as a result of the first suction fan valve 1603 being opened in a state in which the first suction fan 1601 is driven.

As illustrated in FIG. 7, the separation belt 1610 is disposed around the first suction chamber 1602, and the separation belt 1610 serving as a feeding belt is wound around a belt driving roller 1612 and a belt driven roller 1613 illustrated in FIG. 8. Then, as a result of the belt driving roller 1612 being driven by a belt driving motor 1614 (see FIG. 10), the separation belt 1610 rotates, and the belt driven roller 1613 is rotated by the separation belt 1610.

As illustrated in FIG. 7, the separation belt 1610 is provided with a plurality of circular holes 1610a, and the plurality of circular holes 1610a positioned on the lower surface side of the separation belt 1610 communicate with the opening 1602a of the first suction chamber 1602. Therefore, when the inner pressure of the first suction chamber 1602 is a negative pressure, air around the separation belt 1610 can be sucked into the first suction chamber 1602 through the opening 1602a and the plurality of holes 1610a of the separation belt 1610. In the case where there is a sheet near the lower surface of the separation belt 1610, the sheet is attracted to the separation belt 1610 by suction. That is, the first suction unit 1600 attracts the uppermost sheet by suction by negative pressure through the plurality of holes 1610a.

As illustrated in FIG. 4, the driving roller unit 1700 is disposed at a position downstream of the separation belt 1610 in the feeding direction D1, and includes a driving roller 1710 and a driven roller 1720. The driving roller 1710 is driven by a roller driving motor 1711 (see FIG. 10), and the driven roller 1720 is rotated by the driving roller 1710. The sheet S fed while being sucked by the separation belt 1610 is conveyed by the driving roller unit 1700.

As illustrated in FIGS. 4, 5, 7, and 9, the second suction unit 1670 serving as a second suction portion is disposed at an upstream portion that is a portion upstream of the center DC (see FIGS. 3 and 4) of the lifter plate 1002 (sheet S) in the feeding direction D1. That is, the second suction unit 1670 is disposed at a position upstream of the first suction unit 1600. That is, the second suction unit 1670 is disposed at a position upstream of the separation belt 1610 in the feeding direction D1. The second suction unit 1670 includes a second suction fan 1671, a second suction chamber 1672, and a second suction fan valve 1674.

The second suction fan 1671 serving as a second fan is supported by the casing of the feeding deck 100 directly or via a frame or the like. The second suction chamber 1672 serving as a second chamber is connected to and communicates with the second suction fan 1671, and has a space therein. In addition, as illustrated in FIG. 9, the second suction chamber 1672 has an opening 1672a at a position opposing the sheets stacked in the storage container 110, and the opening 1672a communicates with the inner space of the second suction chamber 1672. The second suction fan 1671 can generate a negative pressure in the inner space of the second suction chamber 1672 (the second suction unit 1670 makes a pressure in the inner space of the second suction chamber 1672 negative).

As illustrated in FIG. 5, the second suction fan valve 1674 serving as a second valve is provided between the second suction fan 1671 and the second suction chamber 1672, and is configured to be openable and closable by a second suction fan valve solenoid 1675. The inner pressure of the second suction chamber 1672 becomes a negative pressure as a result of the second suction fan valve 1674 being opened in a state in which the second suction fan 1671 is driven.

As illustrated in FIG. 7, a chamber guide 1676 serving as a guide member is attached to the second suction chamber 1672 so as to cover the opening 1672a, and the chamber guide 1676 is provided with a plurality of circular holes 1676a. The plurality of holes 1676aof the chamber guide 1676 communicate with the opening 1672a of the second suction chamber 1672. Therefore, when the inner pressure of the second suction chamber 1672 is a negative pressure, air around the chamber guide 1676 can be sucked into the second suction chamber 1672 through the opening 1672a and the plurality of holes 1676a of the chamber guide 1676. In the case where there is a sheet near the lower surface of the chamber guide 1676, the sheet is floated toward the chamber guide 1676. That is, the second suction unit 1670 attracts the uppermost sheet by suction by negative pressure through the plurality of holes 1676a.

Meanwhile, as illustrated in FIG. 7, a sheet detection sensor 1620 and a sheet detection flag 1620a are disposed between the separation belt 1610 and the chamber guide 1676 in the feeding direction D1. In addition, a sheet presence/absence detection sensor 1621 and a sheet presence/absence detection flag 1621a are disposed between the separation belt 1610 and the chamber guide 1676 in the feeding direction D1 of the sheet. The sheet detection sensor 1620 and the sheet detection flag 1620a are arranged to be parallel to the sheet presence/absence detection sensor 1621 and the sheet presence/absence detection flag 1621a in the width direction W.

The sheet detection flag 1620a dangles down toward the uppermost sheet of the sheets S stacked on the lifter plate 1002, and comes into contact with the surface of the uppermost sheet when the sheet is fed. The sheet detection sensor 1620 detects the height of the uppermost sheet supported on the lifter plate 1002 on the basis of the position of the sheet detection flag 1620a. The sheet detection flag 1620acomes into contact with the uppermost sheet on the lifter plate 1002, and thus pivots and moves (ascends) from a non-detection position to a detection position. In a state in which the sheet detection flag 1620ahas been moved to and positioned at the detection position, the sheet detection sensor 1620 takes a detecting state (ON). In addition, even if there are no longer any sheets on the lifter plate 1002, the sheet detection flag 1620a is held at the detection position by coming into contact with the lifter plate 1002, as long as the lifter plate 1002 is at a predetermined height. Therefore, the detecting state (ON) of the sheet detection sensor 1620 is maintained.

In addition, the sheet presence/absence detection flag 1621a dangles down toward the uppermost sheet of the sheets S stacked on the lifter plate 1002, and comes into contact with the surface of the uppermost sheet when the sheet is fed. The sheet presence/absence detection sensor 1621 detects the presence/absence of a sheet supported on the lifter plate 1002 on the basis of the position of the sheet presence/absence detection flag 1621a. The sheet presence/absence detection flag 1621acomes into contact with the uppermost sheet on the lifter plate 1002, and thus pivots and moves (ascends) from a non-detection position to a detection position. In a state in which the sheet presence/absence detection flag 1621a has been moved to and positioned at the detection position, the sheet presence/absence detection sensor 1621 takes a detecting state (ON). In addition, in the case where there are no longer any sheets on the lifter plate 1002 and the lifter plate 1002 is at a predetermined height, the sheet presence/absence detection flag 1621a falls into an opening formed in the lifter plate 1002, and thus pivots from the detection position to the non-detection position. Therefore, the sheet presence/absence detection sensor 1621 takes a non-detecting state (OFF).

### Control Block

Next, the configuration of the control system of the feeding deck 100 will be described with reference to FIG. 10. The feeding deck 100 includes an operation portion 390 (see FIG. 1) through which sheet information 1820 that is information about the fed sheet can be input, and a controller 1801. To be noted, the operation portion 390 is connected to the controller 1801 of the feeding deck 100 via the controller of the image forming apparatus 300. In addition, the position of the controller 1801 is not limited to the inside of the feeding deck 100, and the controller 1801 may be disposed in any place in the image forming system 1.

The operation portion 390 is constituted by a physical button, a liquid crystal panel, and the like. The sheet information 1820 includes a sheet size 1820a, a sheet grammage 1820b that is a weight of the sheet per unit area, and a sheet type 1820c representing the type of the sheet such as a plain paper sheet, a coated paper sheet, a synthetic paper sheet, or a PET sheet. The sheet information 1820 (particularly the information of the sheet grammage 1820b) may be input by a user via the operation portion 390, or may be input from an external computer via an interface. In this case, the operation portion 390, the interface, or the like constitutes an input portion for inputting information.

The controller 1801 includes a central processing unit (CPU) 1802, a read-only memory (ROM) 1803, and a random access memory (RAM) 1804. The ROM 1803 stores various programs, and the CPU 1802 loads and executes the programs. The RAM 1804 is used as a work area capable of temporarily storing information processed by the CPU 1802.

The controller 1801 is connected to an environmental sensor 1623, the sheet detection sensor 1620, and the sheet presence/absence detection sensor 1621, and the detection results of these are input thereto. The environmental sensor 1623 can detect the humidity in the storage container 110, that is, a surrounding humidity that is the humidity of the surroundings of the lifter plate 1002. To be noted, the environmental sensor 1623 may detect a surrounding temperature or the like in addition to the surrounding humidity.

The controller 1801 drives the lifting/lowering motor 1009 in a state in which the sheet is not detected by the sheet detection sensor 1620 to move up the lifter plate 1002 described above. Then, when the uppermost sheet of the sheet stack supported on the lifter plate 1002 is detected by the sheet detection sensor 1620, the lifting/lowering motor 1009 is stopped to stop the lifting of the lifter plate 1002. That is, the sheet detection sensor 1620 detects a situation in which the height of the uppermost sheet of the sheet stack is a predetermined height, and the controller 1801 stops the lifting of the lifter plate 1002. In addition, the controller 1801 detects the presence or absence of the sheet on the lifter plate 1002 by the sheet presence/absence detection sensor 1621. Then, when there are no longer any sheets on the lifter plate 1002 in a state in which the lifter plate 1002 is lifted up, the absence of the sheet (emptiness of the storage container 110) is detected by the sheet presence/absence detection sensor 1621.

In addition, the time required for separating the sheets to be fed, the ease of separation, and the like can be estimated in accordance with the sheet information 1820 and the surrounding humidity. Therefore, the controller 1801 sets the optimum sheet feeding condition on the basis of the sheet information 1820 and the surrounding humidity. The feeding condition includes a sheet feeding interval, a feeding speed, and the rotation speeds of the side fan 1651, the front fan 1661, the first suction fan 1601, and the second suction fan 1671.

For example, for sheets having a large grammage or a large size, it is preferable to increase the rotation speed of each fan because the weight of each sheet is heavy. In contrast, for sheets having a small grammage or a small size, since the weight of each sheet is light, if the rotation speed of each fan is increased, the sheet flutters and this can cause a conveyance failure or skew. Therefore, it is preferable to decrease the rotation speed of each fan for sheets of a small grammage or a small size. In addition, for sheets of such a type that the sheets easily stick to each other, the sheets can be stably fed in a separated manner by increasing the rotation speed of each fan or increasing the feeding interval, especially in a high-humidity environment.

The controller 1801 controls the side fan 1651, the side fan valve solenoid 1655, the front fan 1661, and the front fan valve solenoid 1665 on the basis of the set feeding condition. In addition, the controller 1801 controls the first suction fan 1601, the first suction fan valve solenoid 1605, the second suction fan 1671, the second suction fan valve solenoid 1675, and the belt driving motor 1614 on the basis of the set feeding condition.

### Feeding Control According to First Embodiment

Next, the feeding control of the feeding deck 100 according to the first embodiment will be described. In recent years, in the printing industry, there has been a demand for an image forming system (printing equipment, printer, or the like) capable of performing printing on various media sheets. The media sheets have type differences such as plain paper sheets and coated paper sheets, and have grammage differences such as thin paper sheets having small grammage and low rigidity and cardboards having large grammage such as more than 400 gsm that are used for paperware. Further, in such an image forming system, high productivity in which printing can be performed on 100 sheets or more per minute is desired.

For example, also in an image forming system in which sheets are separated by air, there is a need to reliably separate the uppermost sheet from sheets thereunder (hereinafter referred to as lower sheets) when long-length sheets or sheets having high stickiness with each other are fed. In addition, to achieve high productivity, the conveyance time per sheet needs to be shortened. However, for example, even in the case of sheets of a small grammage, if the uppermost sheet sticks to a lower sheet, there is a possibility that a separation failure of the sheet occurs as a result of, for example, not securing enough time for the air delivered to the leading end of the sheet to reach the trailing end of the sheets. Meanwhile, in the case of conveying a cardboard having a grammage larger than 400 gsm, since the weight and rigidity of the sheet are high, the force required for floating the sheets when attracting the sheet to the separation belt by suction is large, and there is a possibility that a conveyance failure occurs as a result of the sheet not floating to the separation belt.

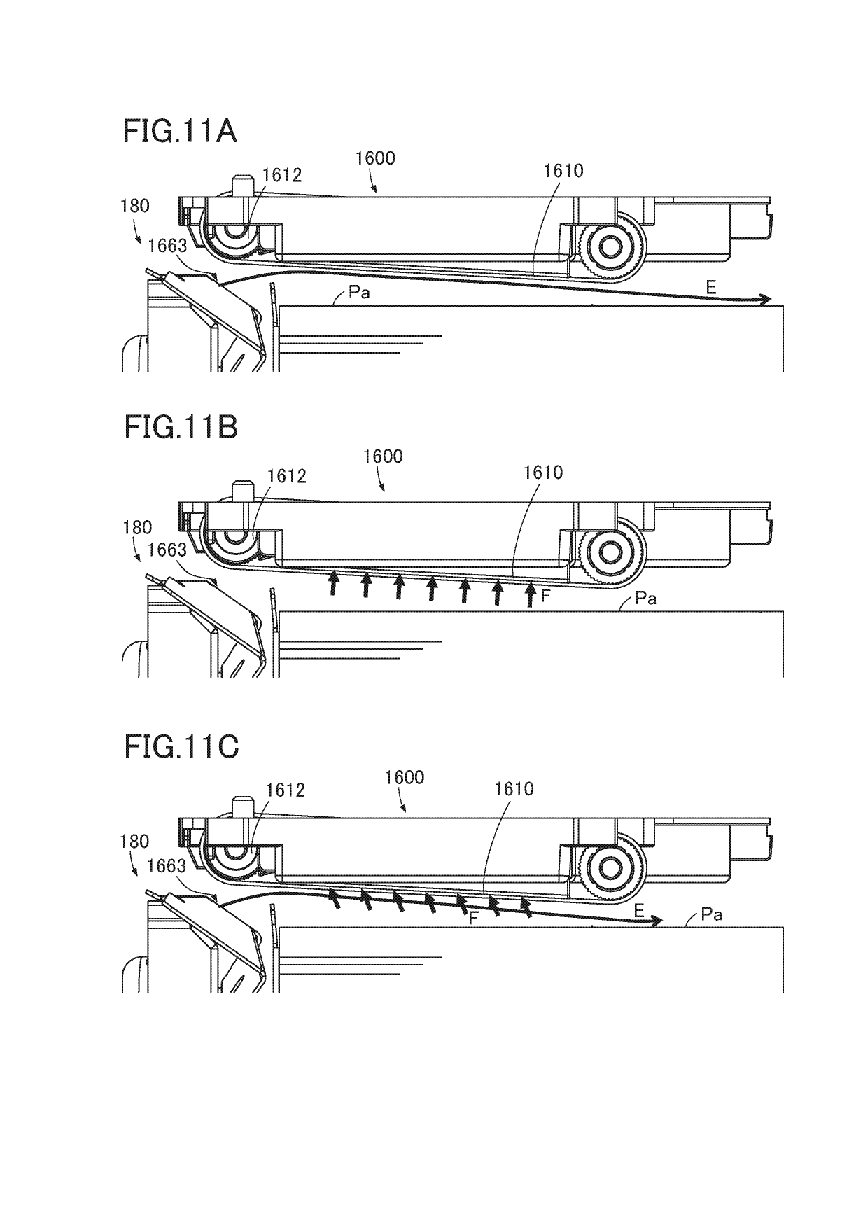

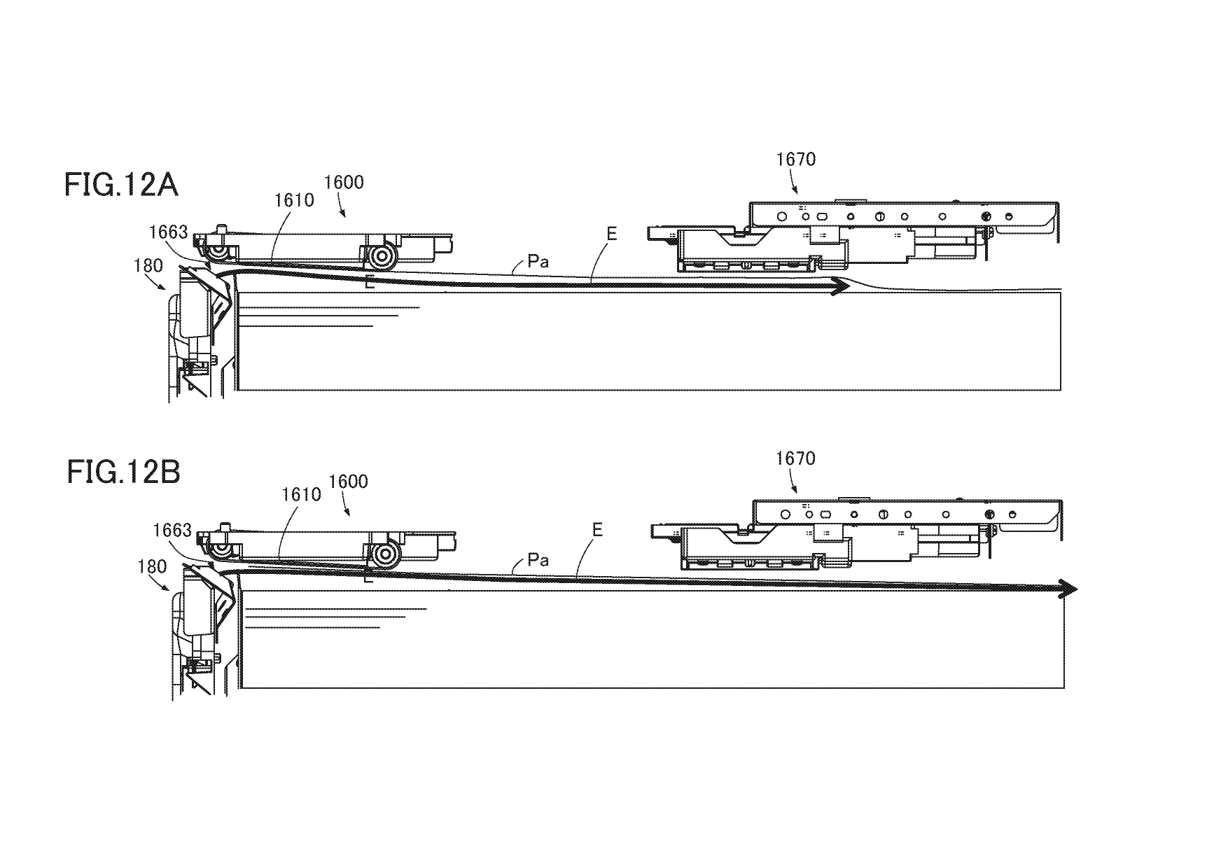

Here, details of the problem described above will be described with reference to FIGS. 1 and 12. FIG. 11A is a front view of the feeding unit in a state in which only the separation air is blown. FIG. 11B is a front view of the feeding unit in a state in which only the first suction air is sucked. FIG. 11C is a front view of the feeding unit in a state in which the separation air is blown and the first suction air is sucked.

As illustrated in FIG. 11A, the separation air unit 180 blows the separation air from the front nozzle 1663 from the downstream side toward the upstream side as indicated by an arrow E. In addition, as illustrated in FIG. 11B, the first suction unit 1600 sucks the first suction air upward through the separation belt 1610 as indicated by an arrow F. In the case where the uppermost sheet Pa is attracted only by suction of the first suction air, a force approximately orthogonal to the uppermost sheet Pa acts on the uppermost sheet Pa, and the uppermost sheet Pa can be sucked by the force of the first suction air.

In contrast, as illustrated in FIG. 11C, in the case where the separation air and the first suction air flow simultaneously, the first suction air and the separation air act in directions orthogonal to each other. In this case, as a result of the separation air indicated by the arrow E, the force from the suction air indicated by the arrow F no longer acts on the uppermost sheet Pa orthogonally, and thus the uppermost sheet Pa cannot be attracted sufficiently by suction. Therefore, in the case of a sheet having a grammage larger than 400 gsm such as a cardboard for which a large suction attraction force is required for floating the uppermost sheet Pa, the sheet cannot be attracted enough to reach the separation belt 1610 when the separation air and the first suction air are in effect simultaneously. Therefore, even if the belt driving roller 1612 is driven in this state, there is a possibility that the sheet does not follow the separation belt 1610 and a conveyance failure occurs.

Next, the posture of the trailing end of the sheet when the leading end of the sheet is attracted and lifted by suction will be described with reference to FIGS. 12A and 12B. FIG. 12A is a front view illustrating a state in which a sheet having a grammage of 400 gsm or less is attracted by suction of the first suction air and the separation air is blown onto the sheet. FIG. 12B is a front view illustrating a state in which a sheet having a grammage larger than 400 gsm is attracted by suction of the first suction air and the separation air is blown onto the sheet.

As illustrated in FIG. 12B, a sheet having a grammage larger than 400 gsm such as a cardboard has a high rigidity, and therefore by attracting the uppermost sheet Pa to the separation belt 1610 by suction, the upstream side of the uppermost sheet Pa can be also lifted up. Therefore, the separation air can reach the trailing end of the sheet by blowing the separation air for only a short period.

In contrast, as illustrated in FIG. 12A, a sheet having a grammage of 400 gsm or less has a low rigidity. Therefore, even if the uppermost sheet Pa is attracted to the separation belt 1610 by suction and the uppermost sheet Pa is attracted by suction of the second suction air by the second suction unit 1670, the upstream side of the uppermost sheet Pa hangs down and cannot be separated from the lower sheets. Therefore, for a sheet having a grammage of 400 gsm or less, the separation air needs to be blown for a long period to separate the sheets from each other up to the trailing end thereof.

As described above, since a sheet having a grammage larger than 400 gsm and a sheet having a grammage of 400 gsm or less have different characteristics, in the first embodiment, the feeding control (feeding operation) can be executed in two modes as described below.

Feeding Control for Sheet Having Grammage of 400 gsm or Less (Feeding Control of First Mode)

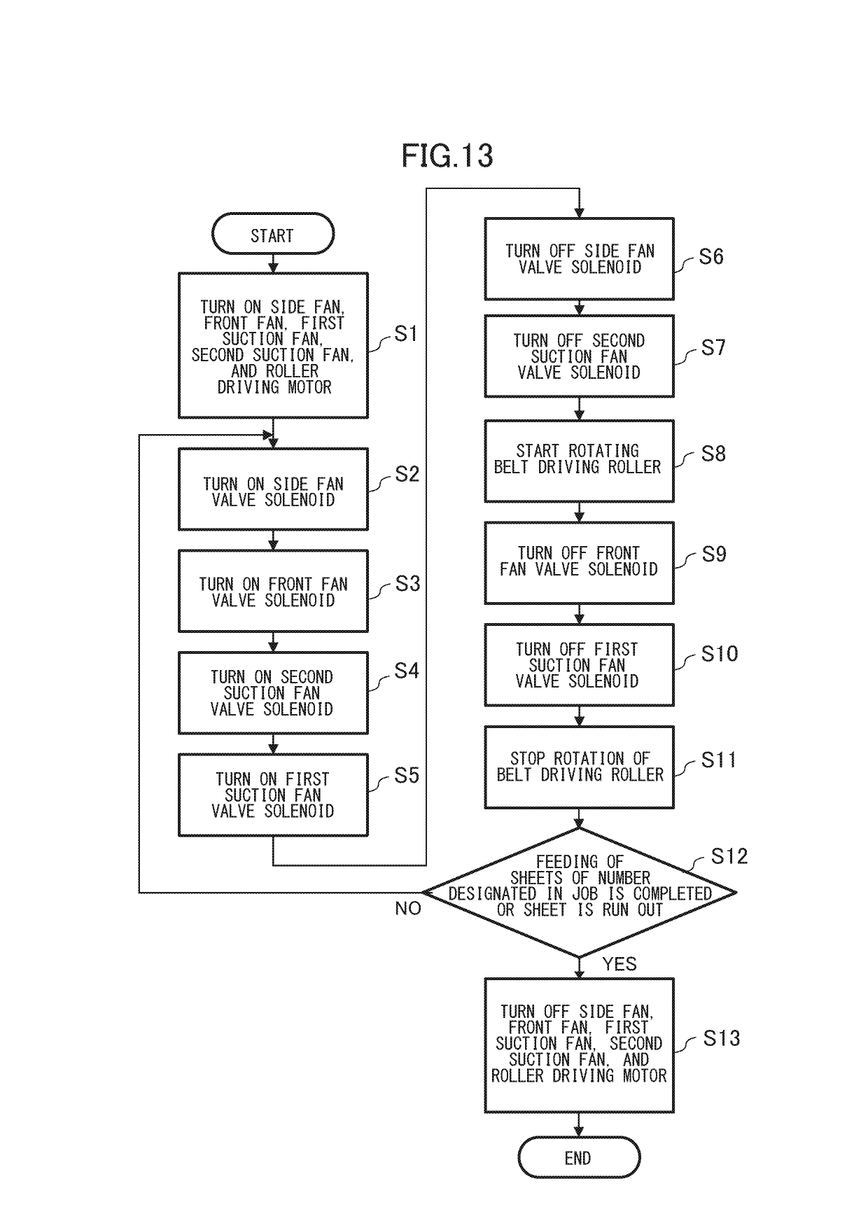

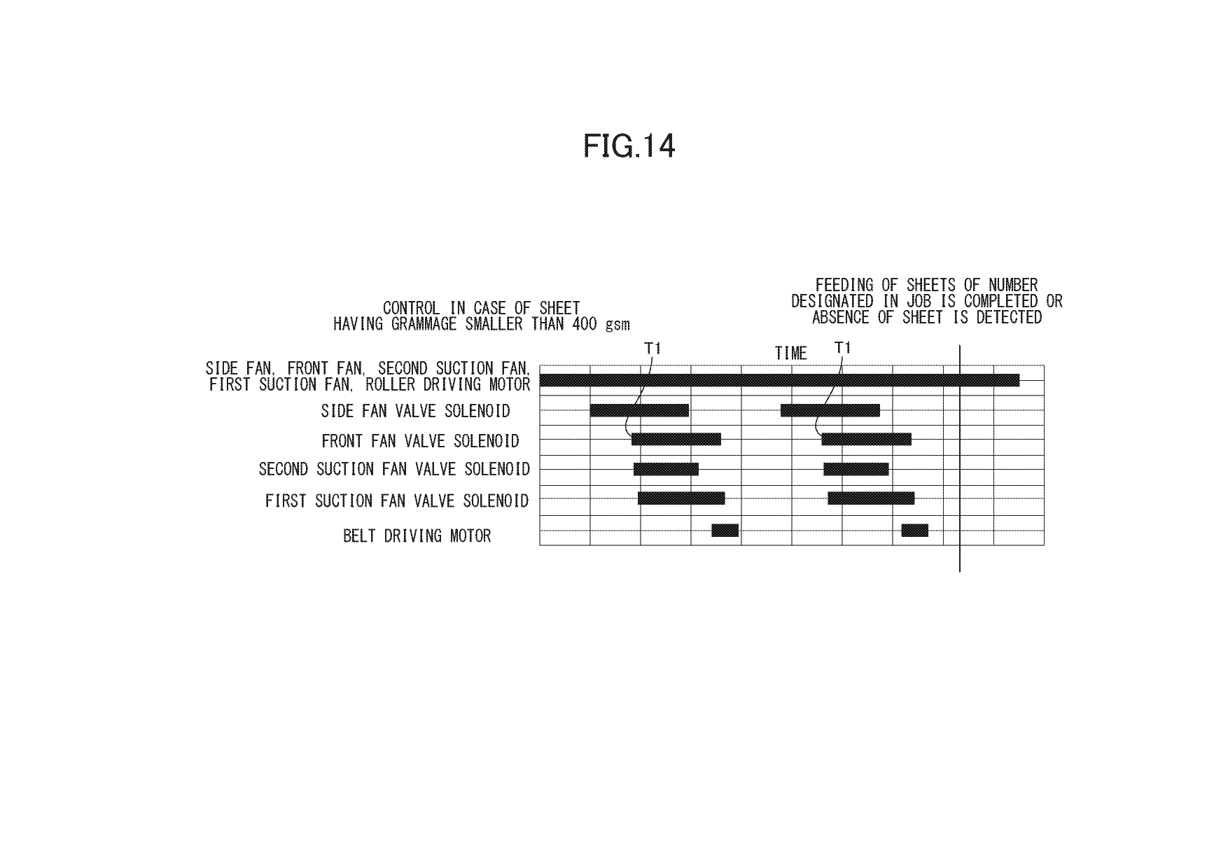

First, feeding control of a first mode that is feeding control for a sheet having a grammage of 400 gsm or less will be described with reference to FIGS. 13 and 14. FIG. 13 is a flowchart illustrating feeding control of the first mode according to the first embodiment in which a sheet other than a cardboard is fed. FIG. 14 is a timing chart illustrating timings when each solenoid is turned on in the feeding control of the first mode according to the first embodiment in which a sheet other than a cardboard is fed.

The controller 1801 of the feeding deck 100 selects a storage container storing a sheet designated in a print job when, for example, starting the print job and starting the feeding of the sheet. In addition, the controller 1801 sets the feeding condition described above in accordance with the sheet information 1820, the surrounding humidity, and the like of the selected storage container. Further, the controller 1801 obtains the grammage of the sheet in the selected storage container from the sheet grammage 1820b of the sheet information 1820. Then, in the case where the grammage of the sheet in the selected storage container is 400 gsm or less, the controller 1801 starts the feeding control of the first mode illustrated in FIG. 13 assuming that the sheet supported in the storage container is a first sheet having a first grammage. To be noted, although a case where the first mode is selected in accordance with the grammage has been described herein, the first mode may be selected assuming that the sheet supported in the storage container is a sheet of a first type having a low rigidity.

As illustrated in FIG. 13, after starting the feeding control of the first mode, the controller 1801 first drives the side fan 1651, the front fan 1661, the first suction fan 1601, and the second suction fan 1671 as a feeding preparation operation (see S1 and FIG. 14). The rotation speed of each fan at this time is set on the basis of the feeding condition described above. In addition, at this time, the side fan valve solenoid 1655, the front fan valve solenoid 1665, the first suction fan valve solenoid 1605, and the second suction fan valve solenoid 1675 are closed (turned OFF).

When each fan reaches the set rotation speed, the controller 1801 transmits a feeding start signal to each portion, and the feeding operation is started. First, the controller 1801 turns on the side fan valve solenoid 1655, and thus opens the side fan valve 1654 (see S2 and FIG. 14). Then, the blowing air generated by the side fan 1651 is blown onto a plurality of sheets including the uppermost sheet of the sheet stack supported on the lifter plate 1002 from the side nozzle 1653, that is, the blowing of the blowing air is started. The blowing air is blown onto a leading end portion and a side end portion of the sheet in the width direction W from one side in the width direction W. This blowing air floats the uppermost portion and the end portion on the leading end side of the sheet stack.

Next, the controller 1801 turns on the front fan valve solenoid 1665, and thus opens the front fan valve 1664 (see S3 and FIG. 14). As a result of this, the separation air generated by the front fan 1661 is blown onto a plurality of sheets including the uppermost sheet of the sheet stack supported on the lifter plate 1002 from the front nozzle 1663, that is, the blowing of the separation air is started. The separation air is blown onto the leading end portion of the sheets from the downstream side toward the upstream side in the feeding direction D1. To be noted, this timing in which the blowing of the separation air is started in the feeding control of the first mode is started will be referred to as a first timing T1 for comparison with the feeding control of the second mode. This first timing T1 is a timing that can be counted with respect to the start of the blowing of the blowing air.

Next, the controller 1801 turns on the second suction fan valve solenoid 1675, and thus opens the second suction fan valve 1674 (see S4 and FIG. 14). As a result of this, the pressure in the inner space of the second suction chamber 1672 becomes a negative pressure. Then, air is sucked through the plurality of holes 1676a in the chamber guide 1676, that is, suction of the second suction air is started, and thus the floating of the uppermost sheet is assisted by the second suction air.

Next, the controller 1801 turns on the first suction fan valve solenoid 1605, and thus opens the first suction fan valve 1603 (see S5 and FIG. 14). As a result of this, the pressure in the first suction chamber 1602 becomes a negative pressure. Then, air is sucked through the plurality of holes 1610a in the separation belt 1610 disposed around the first suction chamber 1602, that is, suction of the first suction air is started, and thus the uppermost sheet floated by the blowing air is attracted to the separation belt 1610.

Here, to reliably separate the uppermost sheet from lower sheets to feed only the uppermost sheet, the separation air needs to flow from the leading end to the trailing end of the uppermost sheet. While the leading end portion of the uppermost sheet is attracted to the separation belt 1610 by suction, the lower sheets drop by gravity when the floating force by the blowing air is removed. At this time, a gap is generated between the uppermost sheet and the lower sheets, the separation air blows into the gap, and thus the separation air flows from the leading end to the trailing end of the uppermost sheet. As a result of this, the separation air flows from the leading end to the trailing end, that is, from the downstream end to the upstream end of the sheet in the feeding direction D1, and thus the separability of the uppermost sheet from the lower sheets can be improved.

Further, in the feeding control of the first mode, the blowing of the separation air onto the leading end of the uppermost sheet from the separation air unit 180 is started first, and then the suction of the second suction air by the second suction unit 1670 and the suction of the first suction air by the first suction unit 1600 are started. As a result of this, the separation air can be blown for a longer period than in the case of performing the blowing and suction of the air are performed in a reversed order. Therefore, even in the case of a sheet having a grammage of 400 gsm or less, the upstream side of the uppermost sheet can be separated from the lower sheets without hanging down.

To be noted, the second suction air in the first embodiment is aimed to assist the floating of the uppermost sheet, and the uppermost sheet does not need to be attracted to the chamber guide 1676 by suction. In addition, in the case of feeding a short-length sheet or a sheet that is less likely to adhere, step S4 does not need to be executed, that is, the second suction fan valve 1674 may be kept closed, or the second suction fan 1671 may be kept stopped without being driven.

Next, the controller 1801 turns off the side fan valve solenoid 1655 to close the side fan valve 1654 (see S6 and FIG. 14), that is, finishes the blowing of the blowing air. Further, the controller 1801 turns off the second suction fan valve solenoid 1675 to close the second suction fan valve 1674 (see S7 and FIG. 14), that is, finishes the suction of the second suction air. This is because the floating of the sheet by the blowing air and the second suction air is no longer needed once the separation air flows from the leading end to the trailing end of the uppermost sheet. As described above, by stopping the blowing air and cancelling the second suction air, the conveyance resistance of the feeding of the uppermost sheet can be reduced, a conveyance failure such as skew can be suppressed. To be noted, the surface of the chamber guide 1676 is formed from a material with a low frictional resistance and configured to reduce the conveyance resistance between the surface of the chamber guide 1676 and the uppermost sheet.

Next, the controller 1801 rotates the separation belt 1610 by driving the belt driving roller 1612 (see S8 and FIG. 14). At this time, the leading end of the uppermost sheet attracted to the separation belt 1610 by suction is positioned above the leading end guide 1003, and therefore the leading end guide 1003 does not interrupt feeding of the uppermost sheet.

Next, after the elapse of a predetermined time since driving the belt driving roller 1612, the controller 1801 turns off the front fan valve solenoid 1665 (see S9 and FIG. 14), and further turns off the first suction fan valve solenoid 1605 (see S10 and FIG. 14). As a result of this, the front fan valve 1664 and the first suction fan valve 1603 are closed, the blowing of the separation air is finished, and the suction of the first suction air is finished. To be noted, the suction attraction of the uppermost sheet to the separation belt 1610 is maintained while the inside of the first suction chamber 1602 is still at a negative pressure.

Next, after a sufficient time has elapsed for the negative pressure in the first suction chamber 1602 to be relieved, the controller 1801 stops the belt driving roller 1612 (see S11 and FIG. 14).

Then, the operation from step S2 to step S11 is repeated (NO in S12) until the feeding of sheets of a number designated in the job is completed or the sheets in the selected storage container are run out. Then, in the case where the feeding of sheets of a number designated in the job is completed or the sheets in the selected storage container are run out (YES in S12), each fan and the roller driving motor 1711 are turned off (see S13 and FIG. 14), and thus the feeding control of the first mode is finished.

Feeding Control for Sheet Having Grammage Larger than 400 gsm (Feeding Control of Second Mode)

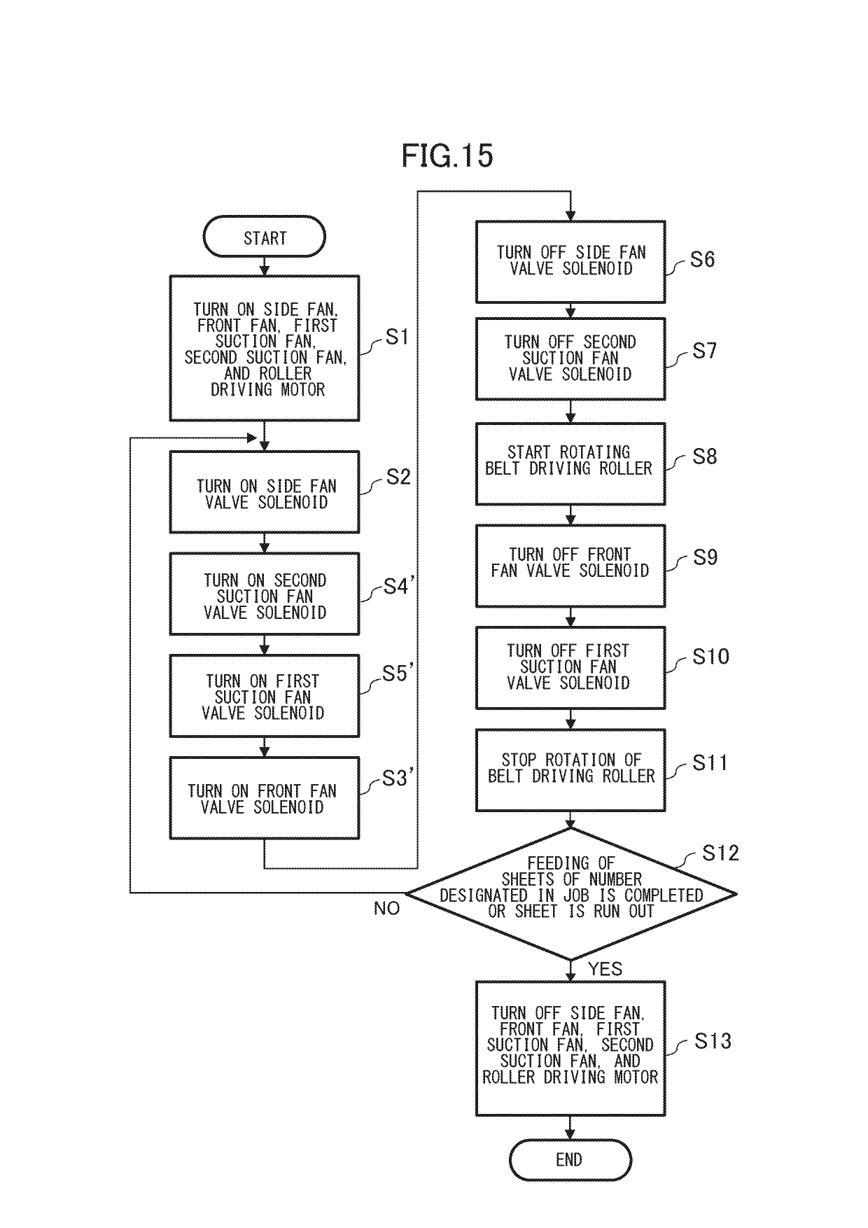

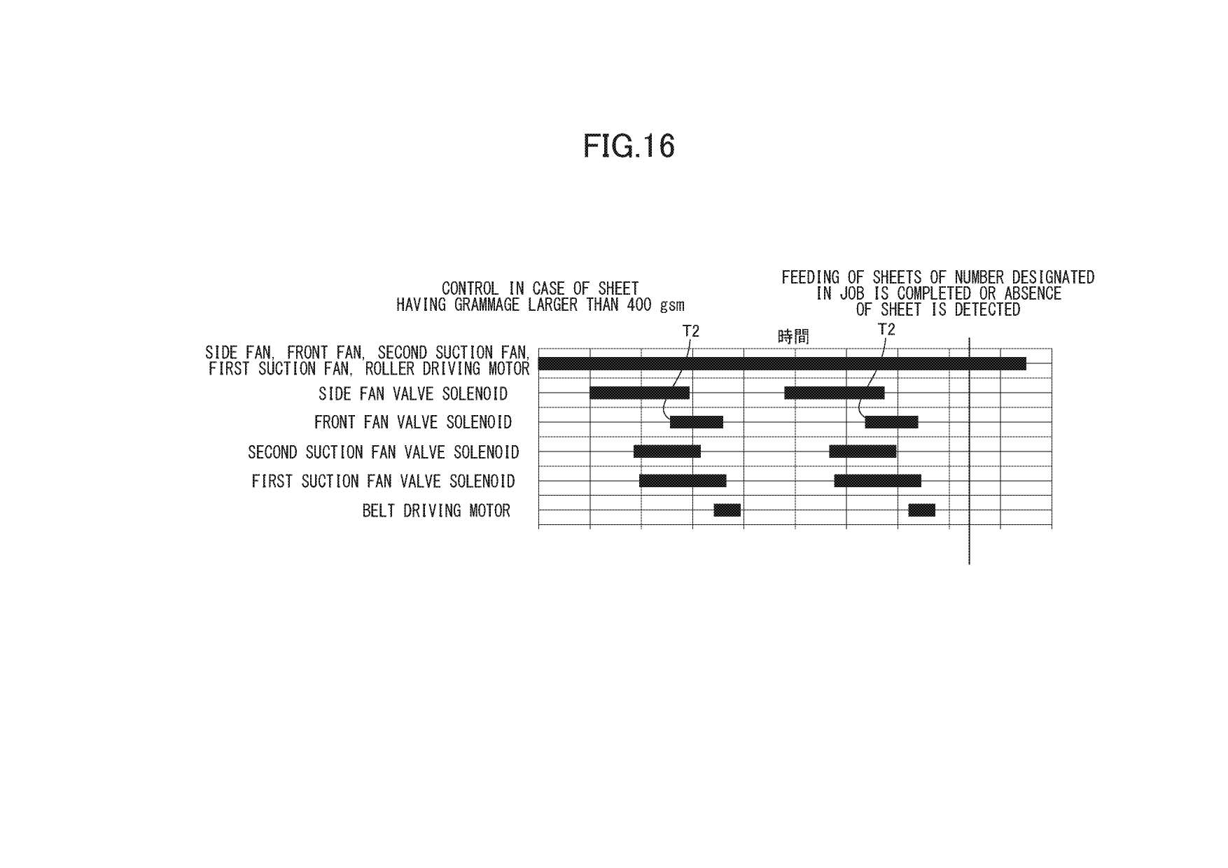

Next, feeding control of a second mode that is feeding control for a sheet having a grammage larger than 400 gsm will be described with reference to FIGS. 15 and 16. FIG. 15 is a flowchart illustrating feeding control of the second mode according to the first embodiment in which a cardboard is fed. FIG. 16 is a timing chart illustrating timings when each solenoid is turned on in the feeding control of the second mode according to the first embodiment in which a cardboard is fed.

Similarly to the first mode, the controller 1801 of the feeding deck 100 selects a storage container storing a sheet designated in a print job when, for example, starting the print job and starting the feeding of the sheet. In addition, the controller 1801 sets the feeding condition described above in accordance with the sheet information 1820, the surrounding humidity, and the like of the selected storage container. Further, the controller 1801 obtains the grammage of the sheet in the selected storage container from the sheet grammage 1820b of the sheet information 1820. Then, in the case where the grammage of the sheet in the selected storage container is larger than 400 gsm, the controller 1801 starts the feeding control of the second mode illustrated in FIG. 15 assuming that the sheet supported in the storage container is a second sheet having a second grammage. To be noted, although a case where the second mode is selected in accordance with the grammage has been described herein, the second mode may be selected assuming that the sheet supported in the storage container is a sheet of a second type having a higher rigidity than the first type.

As illustrated in FIG. 15, after starting the feeding control of the second mode, the controller 1801 first drives the side fan 1651, the front fan 1661, the first suction fan 1601, and the second suction fan 1671 as a feeding preparation operation (see S1 and FIG. 16). The rotation speed of each fan at this time is set on the basis of the feeding condition described above. In addition, at this time, the side fan valve solenoid 1655, the front fan valve solenoid 1665, the first suction fan valve solenoid 1605, and the second suction fan valve solenoid 1675 are closed (turned OFF).

When each fan reaches the set rotation speed, the controller 1801 transmits a feeding start signal to each portion, and the feeding operation is started. First, the controller 1801 turns on the side fan valve solenoid 1655, and thus opens the side fan valve 1654 (see S2 and FIG. 16), that is, starts the blowing of the blowing air. Then, the blowing air generated by the side fan 1651 is blown onto a plurality of sheets including the uppermost sheet of the sheet stack supported on the lifter plate 1002 from the side nozzle 1653. The blowing air is blown onto a leading end portion and a side end portion of the sheet in the width direction W from one side in the width direction W. This blowing air floats the uppermost portion and the end portion on the leading end side of the sheet stack.

Here, in the feeding control of the second mode, the controller 1801 turns on the second suction fan valve solenoid 1675, and thus opens the second suction fan valve 1674 (see S4’ and FIG. 16), that is, starts suction of the second suction air. As a result of this, the pressure in the inner space of the second suction chamber 1672 becomes a negative pressure. Then, air is sucked through the plurality of holes 1676a in the chamber guide 1676, that is, suction of the second suction air is started, and thus the floating of the uppermost sheet is assisted by the second suction air.

Next, the controller 1801 turns on the first suction fan valve solenoid 1605 and thus opens the first suction fan valve 1603 (see S5’ and FIG. 16), that is, starts the suction of the first suction air. As a result of this, the pressure in the first suction chamber 1602 becomes a negative pressure. Then, air is sucked through the plurality of holes 1610a in the separation belt 1610 disposed around the first suction chamber 1602, and thus the uppermost sheet floated by the blowing air is attracted to the separation belt 1610. At this time, since the sheet is floated in a state in which the separation air is not blown, a suction attraction force sufficient for attracting the sheet to the separation belt 1610 can act on a cardboard having a grammage larger than 400 gsm.

Then, the controller 1801 turns on the front fan valve solenoid 1665, and thus opens the front fan valve 1664 (see S3’ and FIG. 16), that is, starts the blowing of the separation air. As a result of this, the separation air generated by the front fan 1661 is blown onto a plurality of sheets including the uppermost sheet of the sheet stack supported on the lifter plate 1002 from the front nozzle 1663. The separation air is blown onto the leading end portion of the sheets from the downstream side toward the upstream side in the feeding direction D1.

As described above, in a state in which the uppermost sheet is attracted to the separation belt 1610 by suction, the separation air blows into a gap between the uppermost sheet and the lower sheets, and thus separates the uppermost sheet from the lower sheets.

Similarly here, to reliably separate the uppermost sheet from lower sheets to feed only the uppermost sheet, the separation air needs to flow from the leading end to the trailing end of the uppermost sheet. While the leading end portion of the uppermost sheet is attracted to the separation belt 1610 by suction, the lower sheets drop by gravity when the floating force by the blowing air is removed. At this time, a gap is generated between the uppermost sheet and the lower sheets, the separation air blows into the gap, and thus the separation air flows from the leading end to the trailing end of the uppermost sheet. As a result of this, the separation air flows from the leading end to the trailing end, that is, from the downstream end to the upstream end of the sheet in the feeding direction D1, and thus the separability of the uppermost sheet from the lower sheets can be improved.

Further, the timing at which the blowing of the separation air is started in the feeding control of the second mode is a second timing T2 later than the first timing T1 in the feeding control of the first mode described above, and is after the suction of the first suction air is started. To be noted, the second timing T2 is also a timing that can be counted with respect to the start of the blowing of the blowing air. As described above, by attracting the uppermost sheet to the separation belt 1610 by the suction of the first suction air before blowing the separation air, the uppermost sheet can be attracted to the separation belt 1610 by a sufficient suction attraction force, thus a separation failure in which the uppermost sheet cannot be separated can be suppressed, and occurrence of conveyance failure can be suppressed.

Next, the controller 1801 turns off the side fan valve solenoid 1655 to close the side fan valve 1654 (see S6 and FIG. 16), that is, finishes the blowing of the blowing air. Further, the controller 1801 turns off the second suction fan valve solenoid 1675 to close the second suction fan valve 1674 (see S7 and FIG. 16), that is, finishes the suction of the second suction air. This is because the floating of the sheet by the blowing air and the second suction air is no longer needed once the separation air flows from the leading end to the trailing end of the uppermost sheet. As described above, by stopping the blowing air and cancelling the second suction air, the conveyance resistance of the feeding of the uppermost sheet can be reduced, and occurrence of a conveyance failure such as skew can be suppressed. To be noted, the surface of the chamber guide 1676 is formed from a material with a low frictional resistance and configured to reduce the conveyance resistance between the surface of the chamber guide 1676 and the uppermost sheet.

Next, the controller 1801 rotates the separation belt 1610 by driving the belt driving roller 1612 (see S8 and FIG. 16). At this time, the leading end of the uppermost sheet attracted to the separation belt 1610 by suction is positioned above the leading end guide 1003, and therefore the leading end guide 1003 does not interrupt feeding of the uppermost sheet.

Next, after the elapse of a predetermined time since driving the belt driving roller 1612, the controller 1801 turns off the front fan valve solenoid 1665 (see S9 and FIG. 16), and further turns off the first suction fan valve solenoid 1605 (see S10 and FIG. 16). As a result of this, the front fan valve 1664 and the first suction fan valve 1603 are closed, the blowing of the separation air is finished, and the suction of the first suction air is finished. To be noted, the suction attraction of the uppermost sheet to the separation belt 1610 is maintained while the inside of the first suction chamber 1602 is still at a negative pressure.

Next, after a sufficient time has elapsed for the negative pressure in the first suction chamber 1602 to be relieved, the controller 1801 stops the belt driving roller 1612 (see S11 and FIG. 16).

Then, the operation from step S2 to step S11 is repeated (NO in S12) until the feeding of sheets of a number designated in the job is completed or the sheets in the selected storage container are run out. Then, in the case where the feeding of sheets of a number designated in the job is completed or the sheets in the selected storage container are run out (YES in S12), each fan and the roller driving motor 1711 are turned off (see S13 and FIG. 16), and thus the feeding control of the first mode is finished.

### Summary of First Embodiment

As described above, in the first embodiment, the feeding control of the first mode in which a sheet having a grammage of 400 gsm or less is fed and feeding control of the second mode in which a sheet having a grammage larger than 400 gsm such as a cardboard is fed can be executed. Further, in the feeding control of the first mode in which a sheet having a grammage of 400 gsm or less is fed, the timing at which the first suction fan valve solenoid 1605 is turned on is set to be later than the timing at which the front fan valve solenoid 1665 is turned on. As a result of this, the time in which the separation air is blown onto the uppermost sheet becomes longer, and thus a sufficient time for separating the uppermost sheet from the lower sheets up to the upstream side of the sheet can be secured. Therefore, a separation failure in which the uppermost sheet cannot be separated can be suppressed, and thus occurrence of a conveyance failure can be suppressed.

Further, in the feeding control of the second mode in which a sheet having a grammage larger than 400 gsm such as a cardboard is fed, the timing at which the front fan valve solenoid 1665 is turned on is set to be later than the timing at which the first suction fan valve solenoid 1605 is turned on. As described above, by attracting the uppermost sheet to the separation belt 1610 by the suction of the first suction air before blowing the separation air, the uppermost sheet can be attracted to the separation belt 1610 by a sufficient suction attraction force, thus a separation failure in which the uppermost sheet cannot be separated can be suppressed, and the occurrence of conveyance failure can be suppressed.

To be noted, the first mode may be a mode in which a sheet having a grammage less than 400 gsm is fed, and the second mode may be a mode in which a sheet having a grammage of 400 gsm or more is fed. That is, a sheet having a grammage of 400 gsm may be fed in either of the first mode and the second mode as long as a sheet having a grammage less than 400 gsm is fed in the first mode and a sheet having a grammage larger than 400 gsm is fed in the second mode.

### Second Embodiment

Next, a second embodiment having a configuration that is partially modified from the first embodiment described above will be described with reference to drawings. To be noted, in the description of the second embodiment, description of part substantially the same as in the first embodiment described above will be omitted.

### Schematic Configuration of Image Forming System

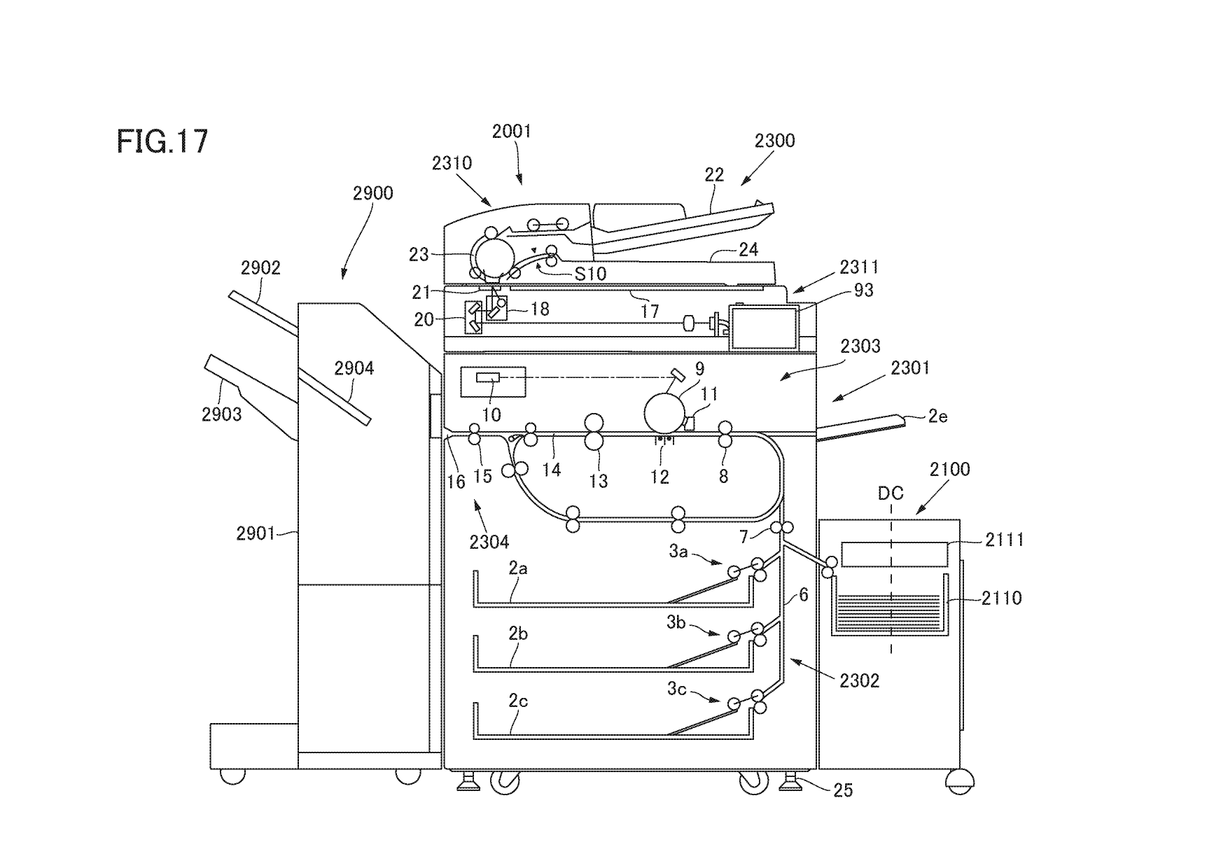

First, a schematic configuration of an image forming system according to the second embodiment will be described. FIG. 17 is a schematic section view of an image forming system according to the second embodiment. An image forming system 2001 includes a feeding deck 2100 serving as a sheet feeding apparatus, an image forming apparatus 2300, and a discharge apparatus 2900 serving as a sheet processing apparatus.

### Feeding Deck

The feeding deck 2100 is constituted by an optional unit that stores sheets of a size that is consumed by a large amount, and includes, in the casing thereof, a storage container 2110 that stores and supports sheets. The sheets stored in the storage container 2110 are picked up and fed by a feeding unit 2111 to the image forming apparatus 2300.

### Image Forming Apparatus

Next, the configuration of the image forming apparatus 2300 will be described. The image forming apparatus 2300 roughly includes an apparatus body 2301 and an image reading apparatus 2310, and the image reading apparatus 2310 includes an image reading unit 2311 and an auto document feeder (ADF) 2312.

The image reading unit 2311 includes a platen glass 17 on which an image document is placed, and a contact glass 21 that guides the document conveyed by the ADF 2312. In addition, the image reading unit 2311 includes a carriage 18 which reciprocates along the platen glass 17 and the contact glass 21 and on which a light source is mounted, and a reduction optical system 20 that guides reflection light from the document on the platen glass 17 or the contact glass 21. Further, the image reading unit 2311 includes an image reading element 19 that photoelectrically converts the reflection light guided by the reduction optical system 20 and reads the reflection light as an image. The image reading element 19 electrically transfers the read image to the image forming portion 2303 of the image forming apparatus body 2301. To be noted, an operation portion 93 that is constituted by a touch panel or the like and that receives an operation of a user is disposed on the front side of the image reading unit 2311.

The ADF 2310 includes a document tray 22, a conveyance path 23 that guides the sheet sent out from the document tray 22 to the contact glass 21, and a discharge tray 24 onto which the document is discharged after its image has been read on the contact glass 21.

In contrast, the apparatus body 2301 of the image forming apparatus 2300 roughly includes a sheet feeding portion 2302 that feeds the sheet, an image forming portion 2303 that forms an image on the sheet, and a sheet discharge portion 2304 that discharges the sheet. In the second embodiment, the image forming portion 2303 is constituted by an electrostatic printing mechanism (so-called laser beam printer). To be noted, installing legs 25 for installing the apparatus on an installation surface (for example, floor surface) are provided on a lower portion of the apparatus body 2301.

The sheet feeding portion 2302 includes a plurality of storage containers 2a, 2b, and 2c that are each a cassette mechanism capable of storing sheets of a different size, and feeding units 3a, 3b, and 3c that respectively feed the sheets in the storage containers 2a, 2b, and 2c. The storage containers 2a, 2b, and 2c are configured to be attachable to and detachable from the apparatus body 2301 such that the sheets can be replenished by drawing out the storage container from the apparatus body 2301. That is, the feeding units 3a, 3b, and 3c are selected to perform the feeding operation in accordance with the sheet size by the controller (controller of the image forming apparatus 2300) omitted in the drawings, and the sheet is fed to the feeding path 6 by the feeding operation. That is, the feeding units 3a, 3b, and 3c are each constituted by, for example, a pickup roller, a separation roller pair, and the like, and each feed a sheet to the feeding path 6 by separating a sheet from other sheets from the storage container 2a, 2b, and 2c. The feeding path 6 is provided with a conveyance roller 7 that conveys the sheet fed from the storage container 2a, 2b, or 2c downstream, and a registration roller pair 8 that corrects the skew by aligning the leading end of the conveyed sheet.

To be noted, the feeding deck 2100 and the manual feed tray 2e are connected to the feeding path 6. In addition, the manual feed tray 2e is constituted such that a special sheet that is difficult to feed in a separated manner such as a cardboard sheet, a coating sheet (that is, coated paper sheet), or a film sheet can be fed.

In the image forming portion 2303, a photosensitive drum 9 serving as a photosensitive member is provided, and a light emitter 10 that emits light onto the photosensitive drum 9, a developing device 11, and a cleaner are disposed around the photosensitive drum 9 that rotates. The image forming portion 2303 illustrated in FIG. 17 is a monochromatic printing mechanism, and optically forms a latent image on the photosensitive drum 9 by the light emitter, toner or ink is attached to this latent image by the developing device 11, and thus a monochromatic toner image is formed.

Then, a sheet is sent to the image forming portion 2303 from the feeding path 6 at a timing matching the timing of image formation by the photosensitive drum 9, and a toner image is transferred onto the sheet by a transfer device 12. Then, a sheet is sent to a fixing device (fixing roller pair) 13 disposed in a discharge path 14 of the sheet discharge portion 2304, and thus the toner image is fixed to the sheet. The sheet discharge portion 2304 is provided with a discharge roller pair 15 and a sheet discharge port 16, and conveys the sheet to the discharge apparatus 2900 that will be described later.

To be noted, the image forming portion 2303 of the image forming apparatus 2300 is not limited to the monochromatic laser beam system described above. For example, printing mechanisms (printing systems) such as an offset printing mechanism, an ink jet printing mechanism, and an ink ribbon transfer printing mechanism (thermal transfer ribbon printing, sublimation ribbon printing, or the like) can be employed.

### Discharge Apparatus

Next, the discharge apparatus 2900 will be described. The discharge apparatus 2900 is an apparatus that processes sheets discharged through the sheet discharge port 16 of the image forming apparatus 2300. The discharge apparatus 2900 includes an apparatus body 2901, an upper discharge tray 2902 and a lower discharge tray 2903 that are disposed on the outside of the apparatus body 2901, and a stack tray 2904 disposed inside the apparatus body 2901. The discharge apparatus 2900 discharges and stacks image-formed sheets on the upper discharge tray 2902 or the lower discharge tray 2903. At this time, the sheets can be stacked for each copy by temporarily stacking the sheets on the stack tray 2904 and then discharging the stack onto the lower discharge tray 2903. To be noted, the discharge apparatus 2900 may be provided with a function to perform a binding process on a plurality of sheets or a function to perform a folding process and a bookbinding process, by including a binding device or a folding device whose illustration is omitted.

### Details of Configuration of Feeding Deck

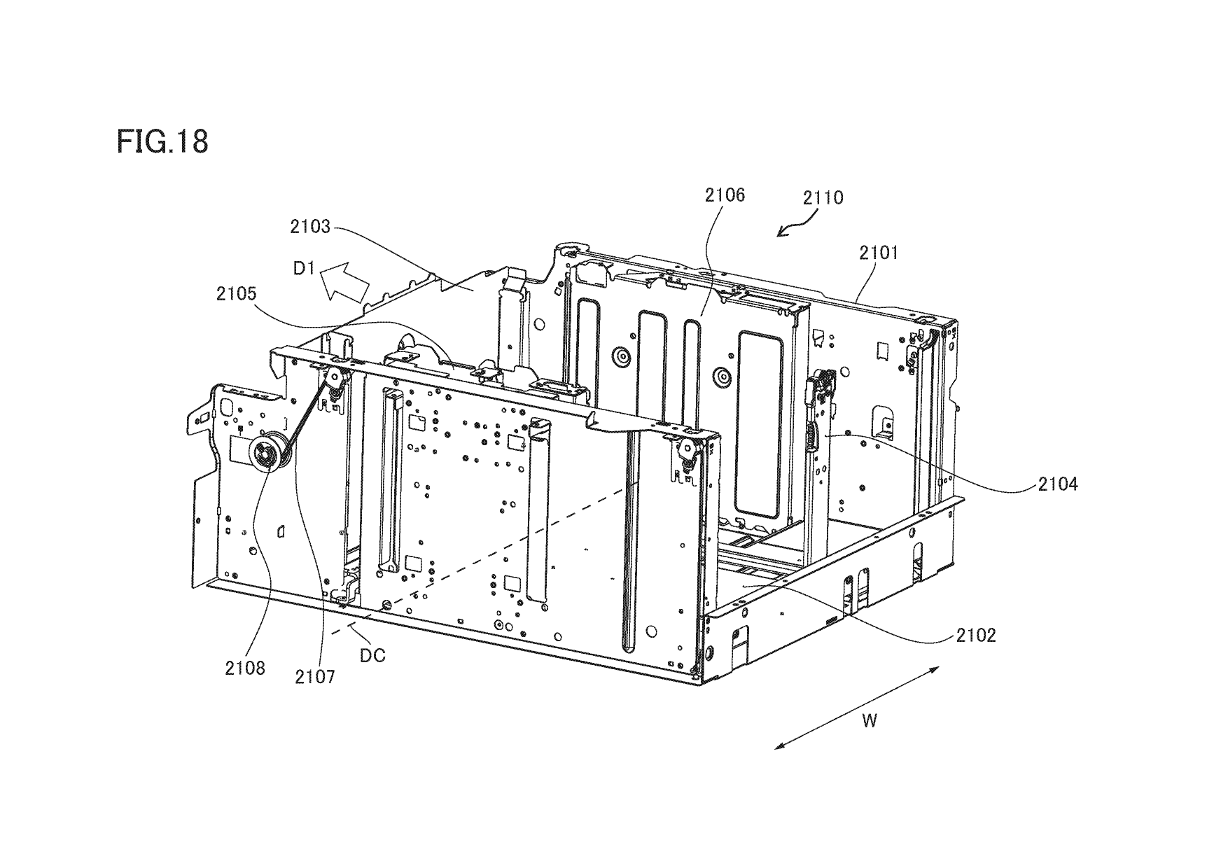

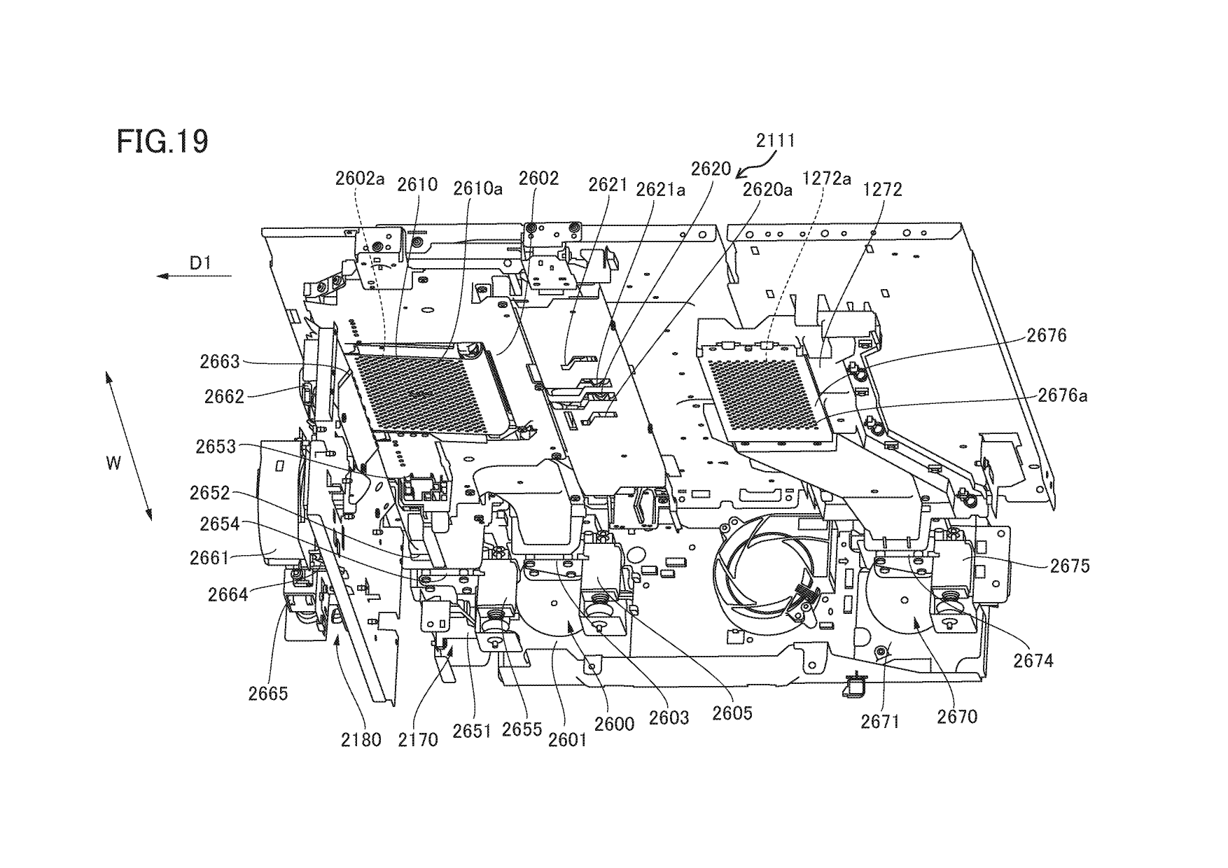

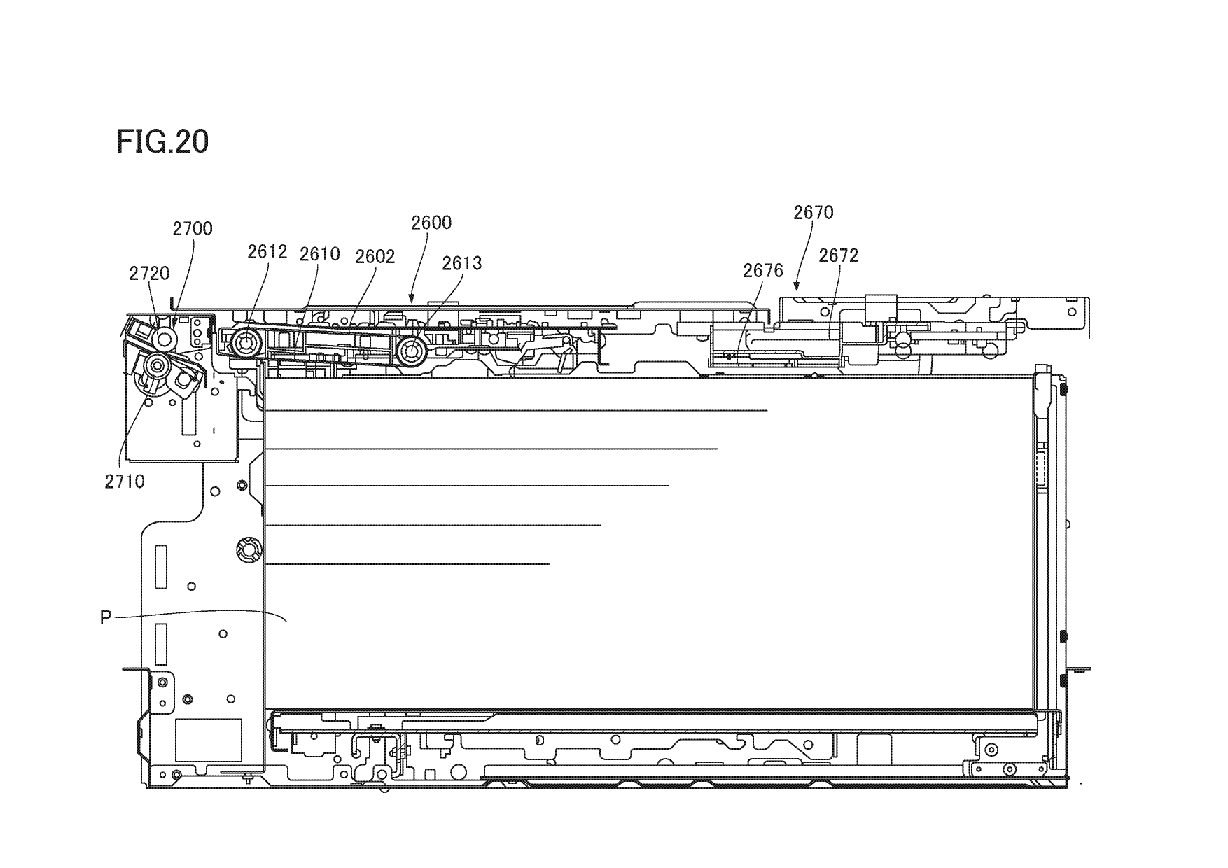

Next, the details of the configuration of the feeding deck 2100 will be described with reference to FIGS. 18-20. FIG. 18 is a perspective view of a storage container according to the second embodiment. FIG. 19 is a perspective view of the feeding unit according to the second embodiment as viewed from obliquely below. FIG. 20 is a front view of the feeding unit according to the second embodiment.

### Storage Container

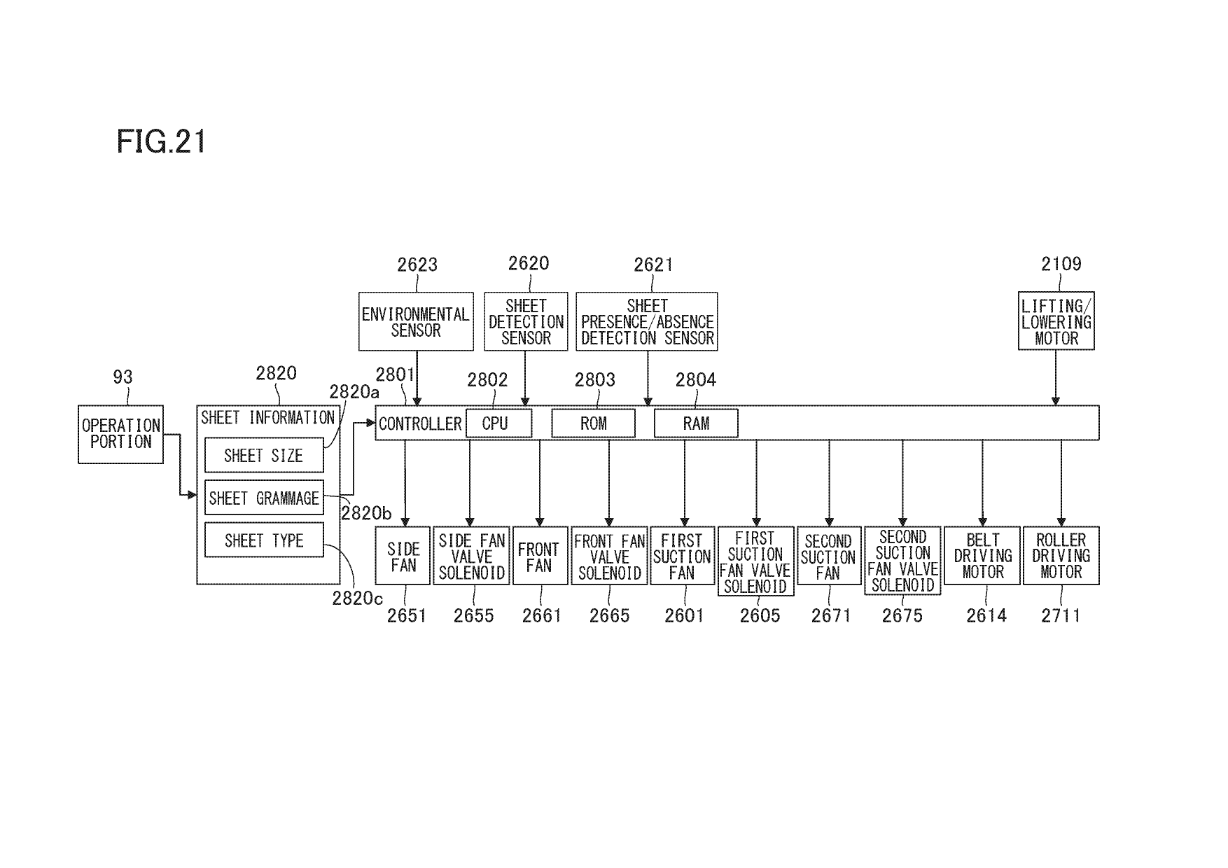

First, the configuration of a storage container 2110 in the feeding deck 2100 will be described. As illustrated in FIG. 18, the storage container 2110 includes a body portion 2101, a lifter plate 2102 supported by the body portion 2101, a leading end guide 2103, a trailing end guide 2104, a first side guide 2105, and a second side guide 2106. The lifter plate 2102 serving as a sheet supporting portion supports a sheet, and is suspended by a lifter wire 2107. Further, the lifter plate 2102 is configured to be movable in the up-down direction while maintaining a state in which the sheets thereon is horizontal, as a result of the lifter wire 2107 being wound up and delivered out by a wire pulley 2108 driven by a lifting/lowering motor 2109 (see FIG. 21).

The leading end guide 2103 regulates the position of the leading end of the sheets stacked on the lifter plate 2102, that is, the position of the downstream end of the sheets in the feeding direction D1. The trailing end guide 2104 regulates the position of the trailing end of the sheets stacked on the lifter plate 2102, that is, the position of the upstream end of the sheets in the feeding direction D1. The first side guide 2105 and the second side guide 2106 are configured to be movable in the width direction W orthogonal to the feeding direction D1, and regulate the position of the end portions in the width direction W of the sheets stacked on the lifter plate 2102. To be noted, the storage container 2110 is configured to be attachable to and detachable from the body portion 2101 in the front-rear direction serving as the width direction W, is moved toward the first side guide 2105 side in the width direction W when being detached, and is moved toward the second side guide 2106 side when being attached.

### Feeding Unit

As illustrated in FIGS. 19 and 20, the feeding unit 2111 floats sheets by the blowing air blown from an end surface of the sheet stack in the width direction. Then, the feeding unit 2111 attracts sheets to a separation belt 2610 by suction air of a negative pressure, and separates one sheet from other sheets by the separation air blown from the leading end side of the sheet stack. Further, the feeding unit 2111 employs a full-air feeding system that feeds sheets one by one by rotating the separation belt 2610 without using a roller for separating sheets.

The feeding unit 2111 includes a blowing air unit 2170, a separation air unit 2180, a first suction unit 2600, a separation belt 2610, a second suction unit 2670, and a driving roller unit 2700.

The blowing air unit 2170 serving as a second blowing portion includes a side fan 2651 whose rotation speed can be controlled, a side duct 2652, a side nozzle 2653, and a side fan valve 2654.

The side fan 2651 serving as a fourth fan is supported by the casing of the feeding deck 2100 directly or via a frame or the like. The side fan 2651 is connected to the side duct 2652 having a tubular shape, and the side nozzle 2653 serving as a second nozzle is provided at the distal end of the side duct 2652. The side duct 2652 and the side nozzle 2653 are provided on the rear side and at a downstream end portion of the storage container 2110 in the feeding direction D1.

The air (hereinafter referred to as blowing air) sent from the side fan 2651 passes through the side duct 2652 and is discharged from the side nozzle 2653. The side duct 2652 is configured to be movable in the width direction W in conjunction with the second side guide 2006 (see FIG. 18). As a result of this, the side nozzle 2653 from which the blowing air is discharged is disposed on the rear side near the leading end portion of the sheets stacked in the storage container 2110.

The side fan valve 2654 serving as a fourth valve is provided between the side fan 2651 and the side duct 2652, and is configured to be openable and closable by a side fan valve solenoid 2655. By controlling the opening and closing of the side fan valve 2654, the blowing timing of the blowing air can be controlled.

The separation air unit 2180 serving as a first blowing portion includes a front fan 2661, a front duct 2662, a front nozzle 2663, and a front fan valve 2664.

The front fan 2661 serving as a third fan is supported by the casing of the feeding deck 2100 directly or via a frame or the like. The front fan 2661 is connected to the front duct 2662 having a tubular shape, and the front nozzle 2663 serving as a first nozzle is provided at the distal end of the front duct 2662. The front duct 2662 and the front nozzle 2663 are provided at a downstream end portion of the storage container 2110 in the feeding direction D1.

The air (hereinafter referred to as separation air) sent from the front fan 2661 passes through the front duct 2662 and is discharged from the front nozzle 2663. The front nozzle 2663 from which the separation air is discharged is directed toward the separation belt 2610 positioned above the sheets stacked on the storage container 2110

The front fan valve 2664 serving as a third valve is provided between the front fan 2661 and the front duct 2662, and is configured to be openable and closable by a front fan valve solenoid 2665. By controlling the opening and closing of the front fan valve 2664, the blowing timing of the separation air can be controlled.

The first suction unit 2600 serving as a first suction portion is disposed at a downstream portion that is a portion downstream of the center DC (see FIGS. 17 and 18) of the lifter plate 2102 (sheet S) in the feeding direction D1. The first suction unit 2600 includes a first suction fan 2601, a first suction chamber 2602, and a first suction fan valve 2603.

The first suction fan 2601 serving as a first fan is supported by the casing of the feeding deck 2100 directly or via a frame or the like. The first suction chamber 2602 serving as a first chamber is connected to the first suction fan 2601, and has a space therein. In addition, the first suction chamber 2602 has an opening 2602a at a position opposing the sheets stacked in the storage container 2110, and the opening 2602a communicates with the inner space of the first suction chamber 2602. The first suction fan 2601 can generate a negative pressure in the inner space of the first suction chamber 2602.

The first suction fan valve 2603 serving as a first valve is provided between the first suction fan 2601 and the first suction chamber 2602, and is configured to be openable and closable by a first suction fan valve solenoid 2605. The inner pressure of the first suction chamber 2602 becomes a negative pressure as a result of the first suction fan valve 2603 being opened in a state in which the first suction fan 2601 is driven.

The separation belt 2610 is disposed around the first suction chamber 2602, and the separation belt 2610 serving as a feeding belt is wound around a belt driving roller 2612 and a belt driven roller 2613. Then, as a result of the belt driving roller 2612 being driven by a belt driving motor 2614 (see FIG. 21), the separation belt 2610 rotates, and the belt driven roller 2613 is rotated by the separation belt 2610.

The separation belt 2610 is provided with a plurality of circular holes 2610a, and the plurality of circular holes 2610a positioned on the lower surface side of the separation belt 2610 communicate with the opening 2602a of the first suction chamber 2602. Therefore, when the inner pressure of the first suction chamber 2602 is a negative pressure, air around the separation belt 2610 can be sucked into the first suction chamber 2602 through the opening 2602a and the plurality of holes 2610a of the separation belt 2610. In the case where there is a sheet near the lower surface of the separation belt 2610, the sheet is attracted to the separation belt 2610 by suction.

The driving roller unit 2700 is disposed at a position downstream of the separation belt 2610 in the feeding direction D1, and includes a driving roller 2710 and a driven roller 2720. The driving roller 2710 is driven by a roller driving motor 2711 (see FIG. 21), and the driven roller 2720 is rotated by the driving roller 2710. The sheet S fed while being sucked by the separation belt 2610 is conveyed by the driving roller unit 2700.

The second suction unit 2670 serving as a second suction portion is disposed at an upstream portion that is a portion upstream of the center DC (see FIGS. 17 and 18) of the lifter plate 2102 (sheet S) in the feeding direction D1. That is, the second suction unit 2670 is disposed at a position upstream of the first suction unit 2600. That is, the second suction unit 2670 is disposed at a position upstream of the separation belt 2610 in the feeding direction D1. The second suction unit 2670 includes a second suction fan 2671, a second suction chamber 2672, and a second suction fan valve 2674.

The second suction fan 2671 serving as a second fan is supported by the casing of the feeding deck 2100 directly or via a frame or the like. The second suction chamber 2672 serving as a second chamber is connected to and communicates with the second suction fan 2671, and has a space therein. In addition, the second suction chamber 2672 has an opening 2672a at a position opposing the sheets stacked in the storage container 2110, and the opening 2672a communicates with the inner space of the second suction chamber 2672. The second suction fan 2671 can generate a negative pressure in the inner space of the second suction chamber 2672.

The second suction fan valve 2674 serving as a second valve is provided between the second suction fan 2671 and the second suction chamber 2672, and is configured to be openable and closable by a second suction fan valve solenoid 2675. The inner pressure of the second suction chamber 2672 becomes a negative pressure as a result of the second suction fan valve 2674 being opened in a state in which the second suction fan 2671 is driven.

A chamber guide 2676 serving as a guide member is attached to the second suction chamber 2672 so as to cover the opening 2672a, and the chamber guide 2676 is provided with a plurality of circular holes 2676a. The plurality of holes 2676aof the chamber guide 2676 communicate with the opening 2672a of the second suction chamber 2672. Therefore, when the inner pressure of the second suction chamber 2672 is a negative pressure, air around the chamber guide 2676 can be sucked into the second suction chamber 2672 through the opening 2672a and the plurality of holes 2676a of the chamber guide 2676. In the case where there is a sheet near the lower surface of the chamber guide 2676, the sheet is floated toward the chamber guide 2676.

Meanwhile, a sheet detection sensor 2620 and a sheet detection flag 2620a are disposed between the separation belt 2610 and the chamber guide 2676 in the feeding direction D1. In addition, a sheet presence/absence detection sensor 2621 and a sheet presence/absence detection flag 2621a are disposed between the separation belt 2610 and the chamber guide 2676 in the feeding direction D1 of the sheet. The sheet detection sensor 2620 and the sheet detection flag 2620a are arranged to be parallel to the sheet presence/absence detection sensor 2621 and the sheet presence/absence detection flag 2621a in the width direction W.

The sheet detection flag 2620a dangles down toward the uppermost sheet of the sheets S stacked on the lifter plate 2102, and comes into contact with the surface of the uppermost sheet when the sheet is fed. The sheet detection sensor 2620 detects the height of the uppermost sheet supported on the lifter plate 2102 on the basis of the position of the sheet detection flag 2620a. The sheet detection flag 2620a comes into contact with the uppermost sheet of the lifter plate 2102, and thus pivots and moves (ascends) from a non-detection position to a detection position. In a state in which the sheet detection flag 2620ahas been moved to and positioned at the detection position, the sheet detection sensor 2620 takes a detecting state (ON). In addition, even if there are no longer any sheets on the lifter plate 2102, the sheet detection flag 2620a is held at the detection position by coming into contact with the lifter plate 2102, as long as the lifter plate 2102 is at a predetermined height. Therefore, the detecting state (ON) of the sheet detection sensor 2620 is maintained.

In addition, the sheet presence/absence detection flag 2621a dangles down toward the uppermost sheet of the sheets S stacked on the lifter plate 2102, and comes into contact with the surface of the uppermost sheet when the sheet is fed. The sheet presence/absence detection sensor 2621 detects the presence/absence of a sheet supported on the lifter plate 2102 on the basis of the position of the sheet presence/absence detection flag 2621a. The sheet presence/absence detection flag 2621acomes into contact with the uppermost sheet of the lifter plate 2102, and thus pivots and moves (ascends) from a non-detection position to a detection position. In a state in which the sheet presence/absence detection flag 2621a has been moved to and positioned at the detection position, the sheet presence/absence detection sensor 2621 takes a detecting state (ON). In addition, in the case where there are no longer any sheets on the lifter plate 2102 and the lifter plate 2102 is at a predetermined height, the sheet presence/absence detection flag 2621a falls into an opening formed in the lifter plate 2102, and thus pivots from the detection position to the non-detection position. Therefore, the sheet presence/absence detection sensor 2621 takes a non-detecting state (OFF).

### Control Block

Next, the configuration of the control system of the feeding deck 2100 will be described with reference to FIG. 21. The feeding deck 2100 includes an operation portion 93 (see FIG. 17) through which sheet information 2820 that is information about the fed sheet can be input, and a controller 2801. To be noted, the operation portion 93 is connected to the controller 2801 of the feeding deck 2100 via the controller of the image forming apparatus 2300. In addition, the position of the controller 2801 is not limited to the inside of the feeding deck 2100, and the controller 2801 may be disposed in any place in the image forming system 1.

The operation portion 93 is constituted by a physical button, a liquid crystal panel, and the like. The sheet information 2820 includes a sheet size 2820a, a sheet grammage 2820b that is a weight of the sheet per unit area, and a sheet type 2820c representing the type of the sheet such as a plain paper sheet, a coated paper sheet, a synthetic paper sheet, or a PET sheet. The sheet information 2820 (particularly the information of the sheet type 2820c) may be input by a user via the operation portion 93, or may be input from an external computer via an interface. In this case, the operation portion 93, the interface, or the like constitutes an input portion for inputting information.

The controller 2801 includes a CPU 2802, a ROM 2803, and a RAM 2804. The ROM 2803 stores various programs, and the CPU 2802 loads and executes the programs. The RAM 2804 is used as a work area capable of temporarily storing information processed by the CPU 2802.

The controller 2801 is connected to an environmental sensor 2623, the sheet detection sensor 2620, and the sheet presence/absence detection sensor 2621, and the detection results of these are input thereto. The environmental sensor 2623 can detect the humidity in the storage container 2110, that is, a surrounding humidity that is the humidity of the surroundings of the lifter plate 2102. To be noted, the environmental sensor 2623 may detect a surrounding temperature or the like in addition to the surrounding humidity.

The controller 2801 drives a lifting/lowering motor 2109 in a state in which the sheet is not detected by the sheet detection sensor 2620 to move up the lifter plate 2102 described above. Then, when the uppermost sheet of the sheet stack supported on the lifter plate 2102 is detected by the sheet detection sensor 2620, the lifting/lowering motor 2109 is stopped to stop the lifting of the lifter plate 2102. That is, the sheet detection sensor 2620 detects a situation in which the height of the uppermost sheet of the sheet stack is a predetermined height, and the controller 2801 stops the lifting of the lifter plate 2102. In addition, the controller 2801 detects the presence or absence of the sheet on the lifter plate 2102 by the sheet presence/absence detection sensor 2621. Then, when there are no longer any sheets on the lifter plate 2102 in a state in which the lifter plate 2102 is lifted up, the absence of the sheet (emptiness of the storage container 2110) is detected by the sheet presence/absence detection sensor 2621.

In addition, the time required for separating the sheets to be fed, the ease of separation, and the like can be estimated in accordance with the sheet information 2820 and the surrounding humidity. Therefore, the controller 2801 sets the optimum sheet feeding condition on the basis of the sheet information 2820 and the surrounding humidity. The feeding condition includes a sheet feeding interval, a feeding speed, and the rotation speeds of the side fan 2651, the front fan 2661, the first suction fan 2601, and the second suction fan 2671.

For example, for sheets having a large grammage or a large size, it is preferable to increase the rotation speed of each fan because the weight of each sheet is heavy. In contrast, for sheets having a small grammage or a small size, since the weight of each sheet is light, if the rotation speed of each fan is increased, the sheet flutters and this can cause a conveyance failure or skew. Therefore, it is preferable to decrease the rotation speed of each fan for sheets of a small grammage or a small size. In addition, for sheets of such a type that the sheets easily stick to each other, the sheets can be stably fed in a separated manner by increasing the rotation speed of each fan or increasing the feeding interval, especially in a high-humidity environment.

The controller 2801 controls the side fan 2651, the side fan valve solenoid 2655, the front fan 2661, and the front fan valve solenoid 2665 on the basis of the set feeding condition. In addition, the controller 2801 controls the first suction fan 2601, the first suction fan valve solenoid 2605, the second suction fan 2671, the second suction fan valve solenoid 2675, and the belt driving motor 2614 on the basis of the set feeding condition.

### Feeding Control According to Second Embodiment

Next, the feeding control of the feeding deck 2100 according to the second embodiment will be described. In recent years, in the printing industry, there has been a demand for an image forming system (printing equipment, printer, or the like) capable of performing printing on various media sheets. The media sheets have type differences such as plain paper sheets and coated paper sheets, and have grammage differences and size differences.

For example, also in an image forming system in which sheets are separated by air, there is a need to reliably separate the uppermost sheet from lower sheets when long-length sheets or sheets that adhere to each other are fed. However, in the case where the uppermost sheet sticks to a lower sheet, there is a possibility that even if the separation air for separating sheets is blown from the leading end toward the trailing end of the sheets, the separation air is dissipated in the width direction midway without reaching the trailing end of the sheets, and a separation failure of the sheet occurs.

That is, in the case where the sheet is a sheet with a high stickiness such as a coated paper sheet and the sheet is a long-length sheet, it is preferable to float the uppermost sheet by sucking the trailing end side (upstream side) of the sheet by the second suction unit 1670. However, similarly to the case where the separation air and the first suction air described above are blown simultaneously (see FIG. 11C), there is an influence in the case where the separation air and the second suction air are blown simultaneously because the directions of the airflow thereof are orthogonal to each other. In this case, the effect of the second suction unit 1670 assisting the floating of the uppermost sheet is weakened, and there is a possibility that a separation failure of the sheets occurs. Therefore, in the second embodiment, feeding control (feeding operation) of the fourth mode is made executable as described below.

### Feeding Control for Sheet Other than Coated Paper Sheet (Feeding Control of Third Mode)

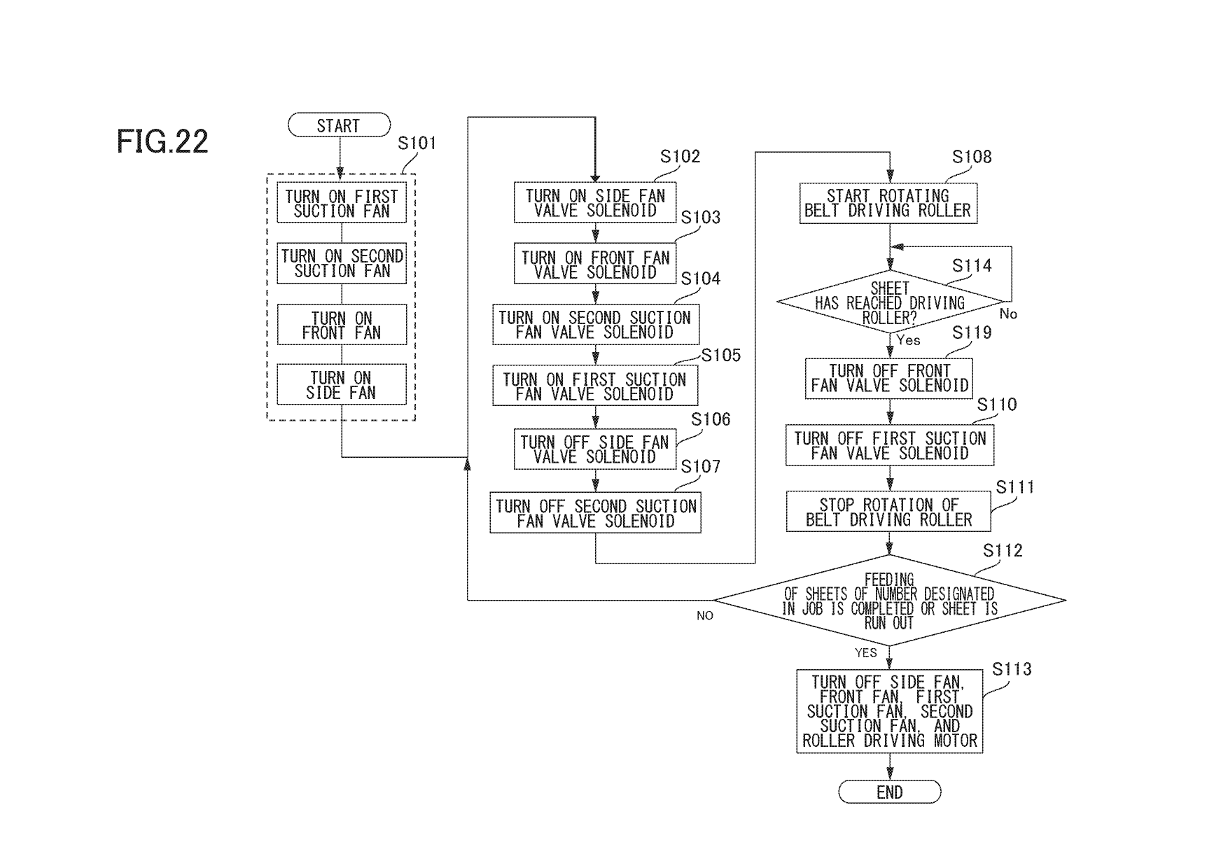

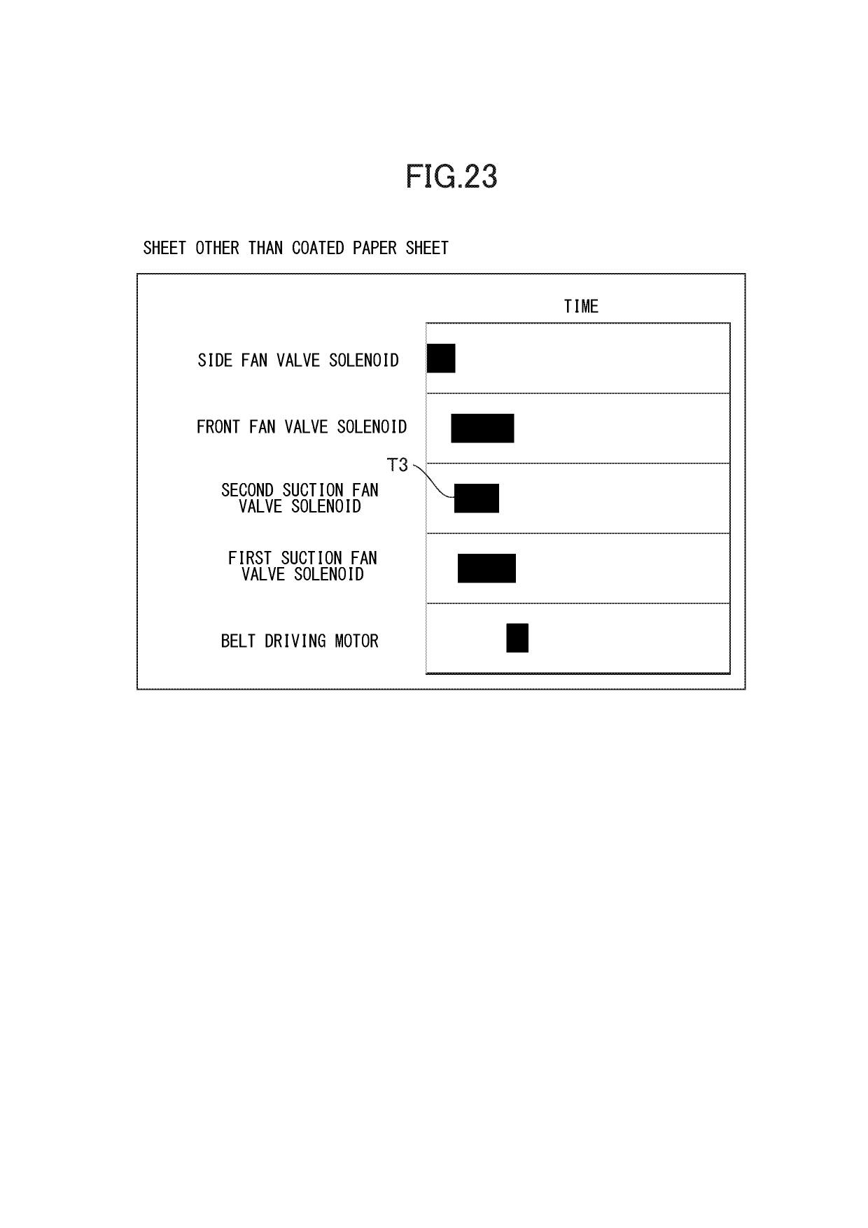

First, feeding control of a third mode that is feeding control for a sheet (plain paper sheet, thin paper sheet, or the like) whose sheet type is other than a coated paper sheet will be described with reference to FIGS. 22 and 23. FIG. 22 is a flowchart illustrating feeding control of the third mode according to the second embodiment in which a sheet other than a coated paper sheet is fed. FIG. 23 is a timing chart illustrating timings when each solenoid is turned on in the feeding control of the third mode according to the second embodiment in which a sheet other than a coated paper sheet is fed. To be noted, in the second embodiment, the feeding control of the third mode can be executed in addition to feeding control of a fourth mode that will be described later, and the feeding control of the third mode is executed in the case of feeding a sheet other than a coated paper sheet. However, the feeding control of the fourth mode may be executed also in the case of feeding a sheet other than a coated paper sheet, that is, a configuration in which the feeding control of the third mode is not provided and not executed may be employed.

For example, feeding of the sheet from the feeding deck 2100 to the image forming apparatus 2300 is commanded by the start of the print job. Then, first, the controller 2801 of the feeding deck 2100 sets the feeding condition described above in accordance with the sheet information 2820, the surrounding humidity, and the like of the storage container 2110. Further, the controller 2801 obtains the type of the sheet in the storage container 2110 from the sheet type 2820c of the sheet information 2820. Then, in the case where the type of the sheet in the storage container 2110 is other than a coated paper sheet, the controller 2801 starts the feeding control of the third mode illustrated in FIG. 22 assuming that the sheet supported in the storage container 2110 is a sheet of a third type.

As illustrated in FIG. 22, after starting the feeding control of the third mode, the controller 2801 first drives the side fan 2651, the front fan 2661, the first suction fan 2601, and the second suction fan 2671 as a feeding preparation operation (S101). The rotation speed of each fan at this time is set on the basis of the feeding condition described above. In addition, at this time, the side fan valve solenoid 2655, the front fan valve solenoid 2665, the first suction fan valve solenoid 2605, and the second suction fan valve solenoid 2675 are closed (turned OFF).

When each fan reaches the set rotation speed, the controller 2801 transmits a feeding start signal to each portion, and the feeding operation is started. First, the controller 2801 turns on the side fan valve solenoid 2655, and thus opens the side fan valve 2654 (see S102 and FIG. 23), that is, the blowing of the blowing air is started. Then, the blowing air generated by the side fan 2651 is blown onto a plurality of sheets including the uppermost sheet of the sheet stack supported on the lifter plate 2102 from the side nozzle 2653. The blowing air is blown onto a leading end portion and a side end portion of the sheet in the width direction W from one side in the width direction W. This blowing air floats the uppermost portion and the end portion on the leading end side of the sheet stack.

Next, the controller 2801 turns on the front fan valve solenoid 2665, and thus opens the front fan valve 2664 (see S103 and FIG. 23), that is, blowing of the separation air is started. As a result of this, the separation air generated by the front fan 2661 is blown onto a plurality of sheets including the uppermost sheet of the sheet stack supported on the lifter plate 2102 from the front nozzle 2663. The separation air is blown onto the leading end portion of the sheets from the downstream side toward the upstream side in the feeding direction D1.

Next, the controller 2801 turns on the second suction fan valve solenoid 2675, and thus opens the second suction fan valve 2674 (see S104 and FIG. 23), that is, suction of the second suction air is started. As a result of this, the pressure in the inner space of the second suction chamber 2672 becomes a negative pressure. Then, air is sucked through the plurality of holes 2676a in the chamber guide 2676, and thus the floating of the uppermost sheet is assisted by the second suction air. To be noted, the timing at which the suction of the second suction air is started in the feeding control of the third mode will be referred to as a third timing T3 for comparison with the feeding control of the fourth mode that will be described later. The third timing T3 is a timing that can be counted with respect to the start of the blowing of the blowing air.

Next, the controller 2801 turns on the first suction fan valve solenoid 2605, and thus opens the first suction fan valve 2603 (see S105 and FIG. 23), that is, suction of the first suction air is started. As a result of this, the pressure in the first suction chamber 2602 becomes a negative pressure. Then, air is sucked through the plurality of holes 2610a in the separation belt 2610 disposed around the first suction chamber 2602, and thus the uppermost sheet floated by the blowing air is attracted to the separation belt 2610.

Here, to reliably separate the uppermost sheet from lower sheets to feed only the uppermost sheet, the separation air needs to flow from the leading end to the trailing end of the uppermost sheet. While the leading end portion of the uppermost sheet is attracted to the separation belt 2610 by suction, the lower sheets drop when the floating force by the blowing air is removed. At this time, a gap is generated between the uppermost sheet and the lower sheets, the separation air blows into the gap, and thus the separation air flows from the leading end to the trailing end of the uppermost sheet. As a result of this, the separation air flows from the leading end to the trailing end, that is, from the downstream end to the upstream end of the sheet in the feeding direction D1, and thus the separability of the uppermost sheet from the lower sheets can be improved.

Further, in the feeding control of the third mode, the blowing of the separation air onto the leading end of the uppermost sheet from the separation air unit 2280 is started first, and then the suction of the second suction air by the second suction unit 2670 and the suction of the first suction air by the first suction unit 2600 are started. As a result of this, the period in which the uppermost sheet is sucked by the second suction unit 2670 can be shortened as compared with the case of performing the blowing and suction of the air in a reversed order. As a result of this, the time during which noise is generated by the second suction air can be shortened, and the damage of the rubbing of the sheet on the chamber guide 1676 can be reduced.

To be noted, the second suction air in the feeding control of the third mode is mainly aimed to assist the floating of the uppermost sheet, and the uppermost sheet does not need to be attracted to the chamber guide 2676 by suction. In addition, step S104 does not need to be executed, that is, the second suction fan valve 2674 may be kept closed, or the second suction fan 2671 may be kept still without being driven.

Next, the controller 2801 turns off the side fan valve solenoid 2655 to close the side fan valve 2654 (see S106 and FIG. 23), that is, finishes the blowing of the blowing air. Further, the controller 2801 turns off the second suction fan valve solenoid 2675 to close the second suction fan valve 2674 (see S107 and FIG. 23), that is, finishes the suction of the second suction air. This is because the floating of the sheet by the blowing air and the second suction air is no longer needed once the separation air flows from the leading end to the trailing end of the uppermost sheet. As described above, by stopping the blowing air and cancelling the second suction air, the conveyance resistance of the feeding of the uppermost sheet can be reduced, and a conveyance failure such as skew can be suppressed. To be noted, the surface of the chamber guide 2676 is formed from a material with a low frictional resistance and configured to reduce the conveyance resistance between the surface of the chamber guide 2676 and the uppermost sheet.

Next, the controller 2801 rotates the separation belt 2610 by driving the belt driving roller 2612 (see S108 and FIG. 23). At this time, the leading end of the uppermost sheet attracted to the separation belt 2610 by suction is positioned above the leading end guide 2103, and therefore the leading end guide 2103 does not interrupt feeding of the uppermost sheet.

Next, the controller 2801 stands by until the sheet reaches the driving roller 2710 (NO in S114), and turns off the front fan valve solenoid 2665 (see S109 and FIG. 23) when the sheet reaches the driving roller 2710 (YES in S114). Further, the controller 2801 turns off the first suction fan valve solenoid 2605 (see S110 and FIG. 23). As a result of this, the front fan valve 2664 and the first suction fan valve 2603 are closed, the blowing of the separation air is finished, and the suction of the first suction air is finished. To be noted, the suction attraction of the uppermost sheet to the separation belt 2610 is maintained while the inside of the first suction chamber 2602 is still at a negative pressure.

Next, after a sufficient time has elapsed for the negative pressure in the first suction chamber 2602 to be relieved, the controller 2801 stops the belt driving roller 2612 (see S111 and FIG. 23).

Then, the operation from step S102 to step S111 is repeated (NO in S112) until the feeding of sheets of a number designated in the job is completed or the sheets in the storage container are run out. Then, in the case where the feeding of sheets of a number designated in the job is completed or the sheets in the storage container are run out (YES in S112), each fan and the roller driving motor 2711 are turned off (S113), and thus the feeding control of the third mode is finished.

### Feeding Control for Coated Paper Sheet (Feeding Control of Fourth Mode)

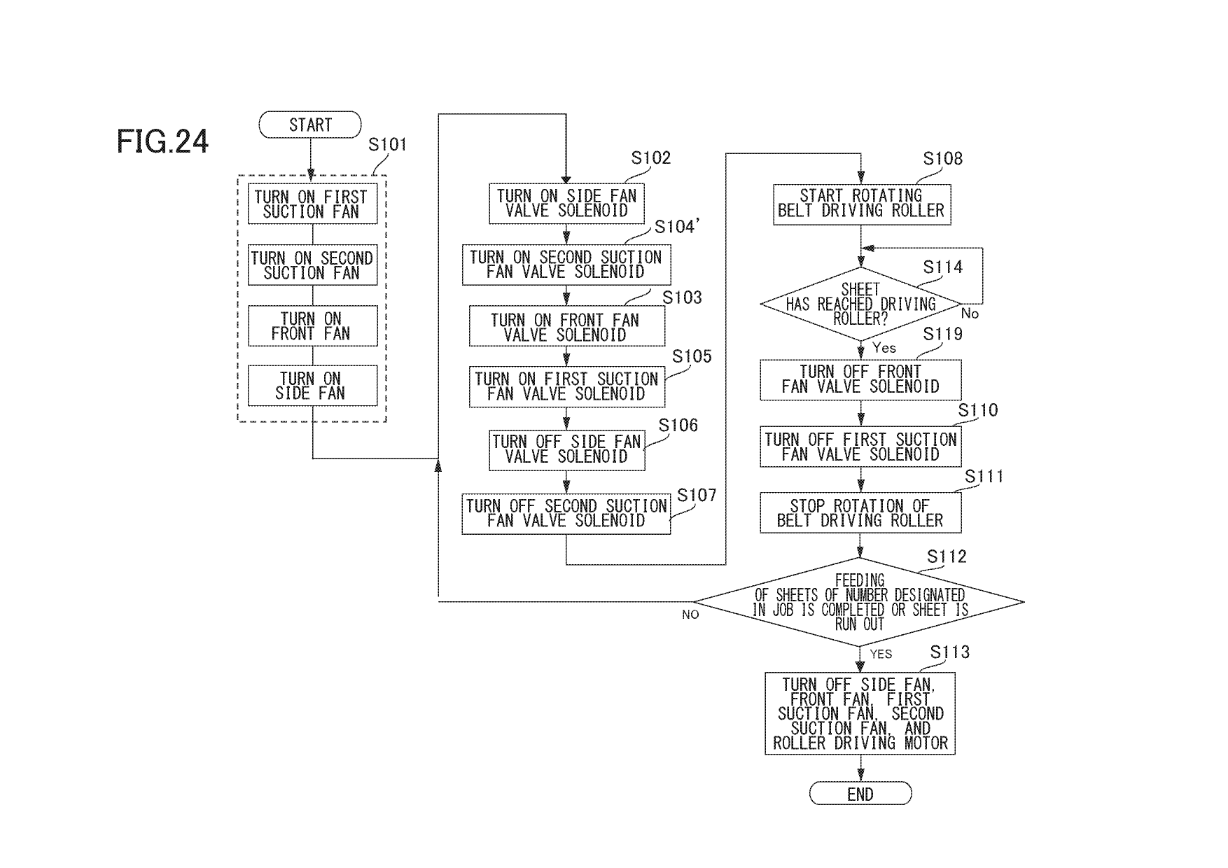

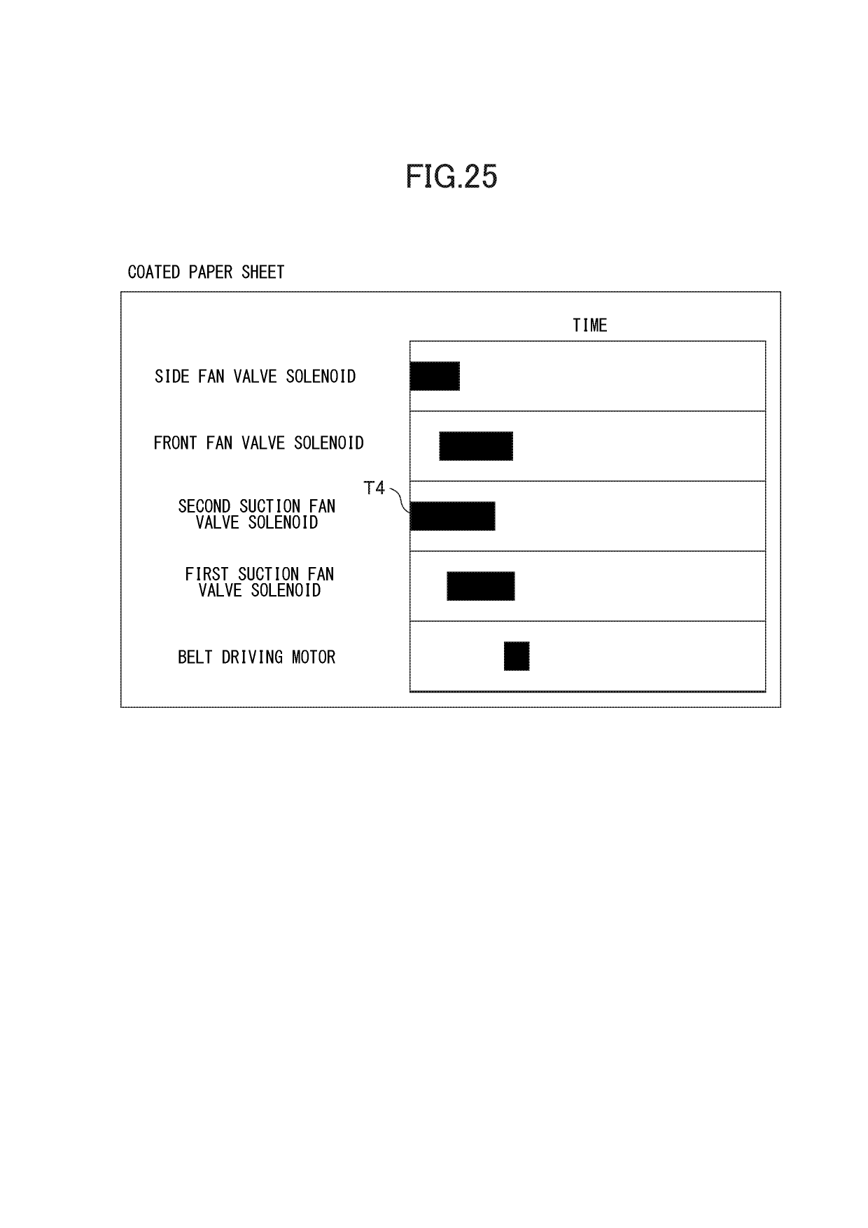

Next, feeding control of a fourth mode that is feeding control in the case where the type of the sheet is a coated paper sheet will be described with reference to FIGS. 24 and 25. FIG. 24 is a flowchart illustrating feeding control of the fourth mode according to the second embodiment in which a coated paper sheet is fed. FIG. 25 is a timing chart illustrating timings when each solenoid is turned on in the feeding control of the fourth mode according to the second embodiment in which a coated paper sheet is fed.

First, similarly to the third mode described above, feeding of the sheet from the feeding deck 2100 to the image forming apparatus 2300 is commanded by the start of the print job. Then, first, the controller 2801 of the feeding deck 2100 sets the feeding condition described above in accordance with the sheet information 2820, the surrounding humidity, and the like of the storage container 2110. Further, the controller 2801 obtains the type of the sheet in the storage container 2110 from the sheet type 2820c of the sheet information 2820. Then, in the case where the type of the sheet in the storage container 2110 is a coated paper sheet, the controller 2801 starts the feeding control of the fourth mode illustrated in FIG. 24 assuming that the sheets supported in the storage container are sheets of a fourth type that stick to each other more strongly than sheets of the third type described above.

As illustrated in FIG. 24, after starting the feeding control of the fourth mode, the controller 2801 drives the side fan 2651, the front fan 2661, the first suction fan 2601, and the second suction fan 2671 as a feeding preparation operation (see S101 and FIG. 25). The rotation speed of each fan at this time is set on the basis of the feeding condition described above. In addition, at this time, the side fan valve solenoid 2655, the front fan valve solenoid 2665, the first suction fan valve solenoid 2605, and the second suction fan valve solenoid 2675 are closed (turned OFF).

When each fan reaches the set rotation speed, the controller 2801 transmits a feeding start signal to each portion, and the feeding operation is started. First, the controller 2801 turns on the side fan valve solenoid 2655, and thus opens the side fan valve 2654 (see S102 and FIG. 25), that is, starts the blowing of the blowing air. Then, the blowing air generated by the side fan 2651 is blown onto a plurality of sheets including the uppermost sheet of the sheet stack supported on the lifter plate 2102 from the side nozzle 2653. The blowing air is blown onto a leading end portion and a side end portion of the sheet in the width direction W from one side in the width direction W. This blowing air floats a portion that is the uppermost portion and the end portion on the leading end side of the sheet stack.

Here, in the feeding control of the fourth mode, the controller 2801 turns on the second suction fan valve solenoid 2675, and thus opens the second suction fan valve 2674 (see S104’ and FIG. 25), that is, starts suction of the second suction air. As a result of this, the pressure in the inner space of the second suction chamber 2672 becomes a negative pressure. Then, air is sucked through the plurality of holes 2676a in the chamber guide 2676, that is, suction of the second suction air is started, and thus the floating of the uppermost sheet is assisted by the second suction air. To be noted, the timing at which the suction of the second suction air is started in the feeding control of the fourth mode will be referred to as a fourth timing T4 earlier than the third timing T3 in the feeding control of the third mode described above. To be noted, the fourth timing T4 is also a timing that can be counted with respect to the start of the blowing of the blowing air.

Next, the controller 2801 turns on the front fan valve solenoid 2665, and thus opens the front fan valve 2664 (see S103 and FIG. 25), that is, starts the blowing of the separation air. As a result of this, the separation air generated by the front fan 2661 is blown onto a plurality of sheets including the uppermost sheet of the sheet stack supported on the lifter plate 2102 from the front nozzle 2663. The separation air is blown onto the leading end portion of the sheets from the downstream side toward the upstream side in the feeding direction D1.

Then, the controller 2801 turns on the first suction fan valve solenoid 2605, and thus opens the first suction fan valve 2603 (see S105 and FIG. 25), that is, suction of the first suction air is started. As a result of this, the pressure in the first suction chamber 2602 becomes a negative pressure. Then, air is sucked through the plurality of holes 2610a in the separation belt 2610 disposed around the first suction chamber 2602, that is, suction of the first suction air is started, and thus the uppermost sheet floated by the blowing air is attracted to the separation belt 2610.

Similarly here, to reliably separate the uppermost sheet from lower sheets to feed only the uppermost sheet, the separation air needs to flow from the leading end to the trailing end of the uppermost sheet. While the leading end portion of the uppermost sheet is attracted to the separation belt 2610 by suction, the lower sheets drop by gravity when the floating force by the blowing air is removed. At this time, a gap is generated between the uppermost sheet and the lower sheets, and it becomes easier for the separation air to blow into the gap.

Further, in a state in which the uppermost sheet is attracted to the separation belt 2610 by suction, the separation air blows into the gap between the uppermost sheet and the lower sheets, and separates the uppermost sheet from the lower sheets. That is, in the feeding control of the fourth mode, the second suction fan valve solenoid 2675 is turned on (step S104’) earlier than when the front fan valve solenoid 2665 is turned on (step S103). As a result of this, the separation air from the separation air unit 2180 does not act orthogonally when assisting the floating of the trailing end of the uppermost sheet by the second suction air from the second suction unit 2670. Therefore, the effect of assisting the floating of the uppermost sheet by the negative pressure in the second suction chamber 2672 is enhanced. Further, then, since the separation air flows from the leading end to the trailing end of the uppermost sheet, dissipation of the air in the width direction W midway can be reduced, and the uppermost sheet can be reliably separated from the lower sheets. As a result of this, even in the case of sheets that strongly stick to each other such as coated paper sheets, the uppermost sheet can be reliably separated from the lower sheets, and occurrence of a conveyance failure can be suppressed.

Next, the controller 2801 turns off the side fan valve solenoid 2655 to close the side fan valve 2654 (see S106 and FIG. 25), that is, finishes the blowing of the blowing air. Further, the controller 2801 turns off the second suction fan valve solenoid 2675 to close the second suction fan valve 2674 (see S107 and FIG. 25), that is, finishes the suction of the second suction air. This is because the floating of the sheet by the blowing air and the second suction air is no longer needed once the separation air flows from the leading end to the trailing end of the uppermost sheet. As described above, by stopping the blowing air and cancelling the second suction air, the conveyance resistance of the feeding of the uppermost sheet can be reduced, a conveyance failure such as skew can be suppressed.

Next, the controller 2801 rotates the separation belt 2610 by driving the belt driving roller 2612 (see S108 and FIG. 25). At this time, the leading end of the uppermost sheet attracted to the separation belt 2610 by suction is positioned above the leading end guide 2103, and therefore the leading end guide 2103 does not interrupt feeding of the uppermost sheet.

Next, the controller 2801 stands by until the sheet reaches the driving roller 2710 (NO in S114), and turns off the front fan valve solenoid 2665 (see S109 and FIG. 25) when the sheet reaches the driving roller 2710 (YES in S114). Further, the controller 2801 turns off the first suction fan valve solenoid 2605 (see S110 and FIG. 25). As a result of this, the front fan valve 2664 and the first suction fan valve 2603 are closed, the blowing of the separation air is finished, and the suction of the first suction air is finished. To be noted, the suction attraction of the uppermost sheet to the separation belt 2610 is maintained while the inside of the first suction chamber 2602 is still at a negative pressure.

Next, after a sufficient time has elapsed for the negative pressure in the first suction chamber 2602 to be relieved, the controller 2801 stops the belt driving roller 2612 (see S111 and FIG. 23).

Then, the operation from step S102 to step S111 is repeated (NO in S112) until the feeding of sheets of a number designated in the job is completed or the sheets in the selected storage container are run out. Then, in the case where the feeding of sheets of a number designated in the job is completed or the sheets in the storage container are run out (YES in S112), each fan and the roller driving motor 2711 are turned off (see S113 and FIG. 25), and thus the feeding control of the fourth mode is finished.

### Summary of Second embodiment

As described above, in the second embodiment, the second suction fan valve solenoid 2675 is turned on before the timing when the front fan valve solenoid 2665 is turned on in the feeding control of the fourth mode in which a coated paper sheet is fed. As a result of this, the effect of assisting the floating of the trailing end of the uppermost sheet by the second suction air is enhanced, dissipation of the separation air in the width direction W midway can be reduced, and the separation air can flow from the leading end to the trailing end of the uppermost sheet. As a result of this, the uppermost sheet can be reliably separated from the lower sheets even in the case of sheets that strongly stick to each other such as coated paper sheets, and occurrence of a conveyance failure can be reduced.

In addition, in the second embodiment, in the case of feeding a sheet other than a coated paper sheet, the feeding control of the third mode can be executed. In the feeding control of the third mode in which a sheet other than a coated paper sheet is fed, the second suction fan valve solenoid 2675 is turned on after the timing when the front fan valve solenoid 2665 is turned on. As a result of this, the time during which noise is generated by the second suction air can be shortened, and damage caused by rubbing of the sheet on the chamber guide 1676 can be reduced.

### Possibility of Other Embodiments

To be noted, although a case where the suction attraction is performed at two respective positions on the downstream side and the upstream side by the first suction unit 1600 or 2600 and the second suction unit 1670 or 2670 has been described in the first and second embodiments described above, the configuration is not limited to this. For example, another suction unit may be provided in addition to the first suction unit 1600 or 2600 and the second suction unit 1670 or 2670, that is, the suction attraction of the uppermost sheet may be performed at three or more positions.

In addition, a case where the suction of the first suction air is started after starting the suction of the second suction air for the feeding control of every one of the first to fourth modes has been described in the first and second embodiments. However, the configuration is not limited to this, and the suction of the second suction air may be started after starting the suction of the first suction air. Particularly in the feeding control of the second mode in the first embodiment, although a case where the suction of the second suction air is started before starting the blowing of the separation air has been described, the blowing of the separation air may be started before starting the suction of the second suction air.

In addition, in the first embodiment, either one of the feeding control of the first mode and the feeding control of the second mode is selected in accordance with whether the grammage of the sheet to be fed is 400 gsmor less or larger than 400 gsm has been described. However, the configuration is not limited to this, and for example, a configuration in which the feeding control of the first mode is selected in the case where the rigidity of the sheet to be fed is lower than a set value and the feeding control of the second mode is selected in the case where the rigidity of the sheet to be fed is higher than the set value may be employed. In addition, the rigidity of the sheet may be determined from the sheet type recorded in the sheet type 1820c, and the mode may be simply selected in accordance with the sheet type instead of by comparing values. That is, a configuration in which the feeding control of the first mode is selected in the case of a sheet of a first type having a low rigidity and the feeding control of the second mode is selected in the case of a sheet of a second type having a higher rigidity than the first type may be employed

In addition, in the first embodiment, a case where either one of the feeding control of the first mode and the feeding control of the second mode is selected in accordance with whether the grammage is 400 gsm or less or larger than 400 gsm has been described. However, the value of the grammage is not limited to 400 gsm, and it is contemplated that the grammage is set to an appropriate value in accordance with, particularly, the performance of each fan, the size of the storage container, and the like.

In addition, in the first embodiment, a case where the order the start of the blowing of the separation air and the start of the suction of the first suction air is relatively switched by setting a second timing at which the blowing of the separation air is started in the second mode to be later than a first timing at which the blowing of the separation air is started in the first mode has been described. However, the configuration is not limited to this, and for example, a configuration in which the timing at which the suction of the first suction air is started is set to be earlier in the second mode than in the first mode may be employed. That is, the timing of the start of the suction of the first suction air and the timing of the start of the blowing of the separation air may be set in any manner as long as these timings are relatively switched. That is, it suffices as long as the suction of the first suction air is started before the start of the blowing of the separation air in the first mode and after the start of the blowing of the separation air in the second mode.

In addition, although a case where the feeding control of the third mode is performed in the case where the sheet to be fed is a sheet other than a coated paper sheet has been described in the second embodiment, the configuration is not limited to this, and for example, the feeding control of the fourth mode may be executed. That is, the order may be any order for other sheets as long as the start of the suction of the second suction air is earlier than the start of the blowing of the separation air in the case of feeding sheets with high stickiness such as coated paper sheets.

In addition, in the second embodiment, a case where either one of the feeding control of the third mode and the feeding control of the fourth mode is selected in accordance with whether or not the sheet type is a coated paper sheet has been described. However, the sheet type is not limited to the coated paper sheet, and may be any sheet type as long as the mode is selected in accordance with whether or not the sheet is a sheet with high stickiness, such as an overhead projector sheet.

In addition, in the second embodiment, a case where the order of the start of the suction of the second suction air and the start of the blowing of the separation air is relatively switched by setting a fourth timing at which the suction of the second suction air is started in the fourth mode to be earlier than a third timing at which the suction of the second suction air is started in the third mode has been described. However, the configuration is not limited to this, and for example, a configuration in which the timing at which the blowing of the separation air is started is set to be later in the fourth mode than in the third mode may be employed. That is, the timing of the start of the suction of the second suction air and the timing of the start of the blowing of the separation air may be set in any manner as long as these timings are relatively switched. That is, it suffices as long as the suction of the second suction air is started after the start of the blowing of the separation air in the third mode and before the start of the blowing of the separation air in the fourth mode.

The present disclosure can also be implemented by a process of providing a program that implements one or more functions of the above-described embodiments to a system or a device via a network or a storage medium, and having one or more processors in a computer of the system or the device read and execute the program. The present disclosure can also be implemented by a circuit (e.g., ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-051528, filed March 26, 2025, which is hereby incorporated by reference herein in its entirety.

What is claimed is:

1. A sheet feeding apparatus comprising:
a sheet supporting portion configured to support sheets;
a first suction portion configured to attract, by suction, an uppermost sheet of the sheets supported on the sheet supporting portion;
a first blowing portion configured to blow air onto the sheets supported on the sheet supporting portion from a downstream side toward an upstream side in a sheet feeding direction; and
a controller capable of executing a first mode in which a first sheet supported on the sheet supporting portion is fed and a second mode in which a second sheet supported on the sheet supporting portion is fed, the first sheet having a first grammage, and the second sheet having a second grammage larger than the first grammage,
wherein the controller is configured to:
in the first mode, start the suction of the uppermost sheet by the first suction portion after starting blowing of the air by the first blowing portion; and
in the second mode, start the suction of the uppermost sheet by the first suction portion before starting the blowing of the air by the first blowing portion.

2. The sheet feeding apparatus according to claim 1, further comprising:
a second suction portion configured to attract, by suction, the uppermost sheet of the sheets supported on the sheet supporting portion at a position upstream of the first suction portion in the sheet feeding direction,
wherein the controller is configured to:
in the first mode, start the suction of the uppermost sheet by the second suction portion after starting the blowing of the air by the first blowing portion; and
in the second mode, start the suction of the uppermost sheet by the second suction portion before starting the blowing of the air by the first blowing portion.

3. The sheet feeding apparatus according to claim 2, wherein the controller is configured to, in the first mode and the second mode, start the suction of the uppermost sheet by the first suction portion after starting the suction of the uppermost sheet by the second suction portion.

4. The sheet feeding apparatus according to claim 1, wherein the controller is configured to set a second timing in which the blowing of the air by the first blowing portion is started in the second mode to be later than a first timing in which the blowing of the air by the first blowing portion is started in the first mode.

5. The sheet feeding apparatus according to claim 4, further comprising:
a second blowing portion configured to blow air onto the sheets in a width direction orthogonal to the sheet feeding direction of the sheets supported on the sheet supporting portion from one side in the width direction,
wherein the controller is configured to:
in the first mode and the second mode, start the suction of the uppermost sheet by the first suction portion and the blowing of the air by the first blowing portion after starting the blowing of the air by the second blowing portion; and
the first timing and the second timing are later than start of the blowing of the air by the second blowing portion.

6. The sheet feeding apparatus according to claim 1, further comprising:
a second blowing portion configured to blow air onto the sheets in a width direction orthogonal to the sheet feeding direction of the sheets supported on the sheet supporting portion from one side in the width direction,
wherein the controller is configured to:
in the first mode and the second mode, start the suction of the uppermost sheet by the first suction portion and the blowing of the air by the first blowing portion after starting the blowing of the air by the second blowing portion.

7. The sheet feeding apparatus according to claim 1,
wherein the first sheet has a grammage smaller than 400 gsm, and
wherein the second sheet has a grammage larger than 400 gsm.

8. A sheet feeding apparatus comprising:
a sheet supporting portion configured to support sheets;
a first suction portion configured to attract, by suction, an uppermost sheet of the sheets supported on the sheet supporting portion;
a first blowing portion configured to blow air onto the sheets supported on the sheet supporting portion from a downstream side toward an upstream side in a sheet feeding direction; and
a controller capable of executing a first mode in which a sheet of a first type supported on the supporting portion is fed and a second mode in which a sheet of a second type supported on the sheet supporting portion is fed, the second type having a higher rigidity than the first type,
wherein the controller is configured to:
in the first mode, start the suction of the uppermost sheet by the first suction portion after starting blowing of the air by the first blowing portion; and
in the second mode, start the suction of the uppermost sheet by the first suction portion before starting the blowing of the air by the first blowing portion.

9. A sheet feeding apparatus comprising:
a sheet supporting portion configured to support sheets;
a first suction portion configured to attract, by suction, an uppermost sheet of the sheets supported on the sheet supporting portion;
a second suction portion disposed at a position upstream of the first suction portion in a sheet feeding direction and configured to attract, by suction, the uppermost sheet of the sheets supported on the sheet supporting portion;
a first blowing portion configured to blow air onto the sheets supported on the sheet supporting portion from a downstream side toward an upstream side in the sheet feeding direction; and
a controller capable of executing a third mode in which a sheet of a third type supported on the supporting portion is fed and a fourth mode in which a sheet of a fourth type supported on the sheet supporting portion is fed, sheets of the fourth type sticking more strongly to each other than sheets of the third type,
wherein the controller is configured to:
in the third mode, start the suction of the uppermost sheet by the second suction portion after starting blowing of the air by the first blowing portion; and
in the fourth mode, start the suction of the uppermost sheet by the second suction portion before starting the blowing of the air by the first blowing portion.

10. The sheet feeding apparatus according to claim 9, wherein the second suction portion includes a second suction chamber, and is configured to make a pressure in an inner space of the second suction chamber negative.

11. The sheet feeding apparatus according to claim 9, wherein the controller is configured to, in the third mode and the fourth mode, start the suction of the uppermost sheet by the first suction portion after starting the blowing of the air by the first blowing portion, and start the suction of the uppermost sheet by the first suction portion after starting the suction of the uppermost sheet by the second suction portion

12. The sheet feeding apparatus according to claim 9, wherein the controller is configured to set a fourth timing at which the suction of the uppermost sheet by the second suction portion is started in the fourth mode to be earlier than a third timing at which the suction of the uppermost sheet by the second suction portion is started in the third mode.

13. The sheet feeding apparatus according to claim 12, further comprising:
a second blowing portion configured to blow air onto the sheets in a width direction orthogonal to the sheet feeding direction of the sheets supported on the sheet supporting portion from one side in the width direction,
wherein the controller is configured to:
in the third mode and the fourth mode, start the suction of the uppermost sheet by the first suction portion and the blowing of the air by the first blowing portion after starting the blowing of the air by the second blowing portion; and
the third timing and the fourth timing are later than start of the blowing of the air by the second blowing portion.

14. The sheet feeding apparatus according to claim 9, further comprising:
a second blowing portion configured to blow air onto the sheets in a width direction orthogonal to the sheet feeding direction of the sheets supported on the sheet supporting portion from one side in the width direction,
wherein the controller is configured to:
in the third mode and the fourth mode, start the suction of the uppermost sheet by the first suction portion and the blowing of the air by the first blowing portion after starting the blowing of the air by the second blowing portion.

15. The sheet feeding apparatus according to claim 9,
wherein the sheet of the third type is a sheet other than a coated paper sheet, and
wherein the sheet of the fourth type is a coated paper sheet.

16. The sheet feeding apparatus according to claim 1,
wherein the first suction portion includes a feeding belt provided with a plurality of holes and configured to attract the uppermost sheet by suction by negative pressure through the plurality of holes,
wherein the first suction portion includes a first fan, a first chamber communicating with the plurality of holes of the feeding belt, and a first valve configured to be opened and closed between the first fan and the first chamber, and
wherein the controller is configured to cause the first suction portion to perform suction attraction by opening the first valve in a state in which the first fan is driven.

17. The sheet feeding apparatus according to claim 2,
wherein the second suction portion includes a guide member provided with a plurality of holes and configured to guide and attract the uppermost sheet by suction by negative pressure through the plurality of holes,
wherein the second suction portion includes a second fan, a second chamber communicating with the plurality of holes of the guide member and a second valve configured to be opened and closed between the second fan and the second chamber, and
wherein the controller is configured to cause the second suction portion to perform suction attraction by opening the second valve in a state in which the second fan is driven.

18. The sheet feeding apparatus according to claim 1,
wherein the first blowing portion includes a third fan, a first nozzle, and a third valve configured to be opened and closed between the third fan and the first nozzle, and
wherein the controller is configured to cause the first blowing portion to perform the blowing by opening the third valve in a state in which the third fan is driven.

19. The sheet feeding apparatus according to claim 6,
wherein the second blowing portion includes a fourth fan, a second nozzle, and a fourth valve configured to be opened and closed between the fourth fan and the second nozzle, and
wherein the controller is configured to cause the second blowing portion to perform the blowing by opening the fourth valve in a state in which the fourth fan is driven.

20. An image forming system comprising:
the sheet feeding apparatus according to claim 1; and
an image forming apparatus configured to form an image on a sheet.
